(19) United States
(12) Patent Application Publication
(10) Pub. No.: US 2026/0089235 A1
(43) Pub. Date: Mar. 26, 2026

(54) ENHANCED VEHICLE DIGITAL TWIN SYSTEMS AND METHODS

(71) Applicant: QUALCOMM Incorporated, San Diego, CA (US)

(72) Inventors: Ahmed Farhan Hanif, Versailles (FR); Tien Viet Nguyen, Bridgewater, NJ (US); Dan Vassilovski, Del Mar, CA (US); Kapil Gulati, Belle Mead, NJ (US)

(21) Appl. No.: 18/891,562

(22) Filed: Sep. 20, 2024

(51) Int. Cl. H04L 67/5682; G07C 5/08; H04L 67/00

(52) U.S. Cl. CPC H04L 67/5682; G07C 5/0875; H04L 67/34

(57) ABSTRACT

This disclosure provides systems, methods, and devices for wireless communication that support enhanced vehicle digital twin operations. In a first aspect, an apparatus for wireless communication at a vehicle includes one or more sensors, at least one processor, and a memory coupled to the at least one processor. The at least one processor is configured to cause the apparatus to associate changes in operations of the vehicle with changes in in-vehicle network (IVN) performance and electronic control unit (ECU) performance to generate association data. The at least one processor is further configured to cause the apparatus to provide the association data to a digital twin associated with the vehicle, and the association data is configured to cause the digital twin to model performance of the vehicle and generate modified operating parameters. Other aspects and features are also claimed and described.

### TECHNICAL FIELD

Aspects of the present disclosure relate generally to wireless communication systems, and more particularly, to using digital twins to model vehicles and vehicle networks. Some features may enable and provide improved vehicle operations and communications, including improved in-vehicle network (IVN) operations.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as network nodes (e.g., base stations or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the other network nodes or from other wireless RF transmitters. This interference may degrade performance on both the downlink and uplink. Additionally, UEs may communicate with one another directly and may communicate with other non-base station network nodes directly, such as via a sidelink channel and independent of relay by a base station.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Presently, entities across many different industries are seeking to incorporate the use of digital twins to test, streamline, or otherwise evaluate various aspects of their operations. One such industry is wireless communications, where digital twins have been proposed as a means to analyze and evaluate performance of a wireless network or wireless device. Another such industry is the automotive industry, where digital twins have been proposed as a means to analyze and evaluate performance of a vehicle. To illustrate, the use of a digital twin has been proposed as a means to safely evaluate performance of autonomous vehicles in mixed driver environments (i.e., environments where autonomous vehicles are operating in the vicinity of human drivers). As can be appreciated from the non-limiting example(s) above, the ability to analyze performance or other factors of a system or process using a digital twin, rather than its real world counterpart (e.g., the network or vehicle represented by the digital twin), can provide significant advantages. Although the use of digital twins may be useful across many different industries, much of the current interest is focused on the benefits that may be realized by using digital twins, and other challenges of using digital twins have gone unaddressed.

One particular challenge with respect to the use of digital twins is maintaining and updating the digital twins after creation of the digital twins themselves to keep up with evolving systems or processes. Specifically, as the systems upon which they are based or modeled may evolve and change, the digital twins must be updated to ensure the changes are reflected in the digital twins and underlying data or knowledge models. However, there are no update mechanisms for digital twins. For example, tools currently exist to aid in the creation of digital twins, but most existing tools are limited in the sense that they are manual processes, data intensive, and expertise driven. Additionally, an entity may offer a digital twin platform specific to systems, products, or services of the entity, but such digital twin platforms may not be capable of being utilized for other systems, products, or services (i.e., the digital twin platform is only compatible with the entity's system(s), products, services, etc.). Furthermore, such entity-specific digital twins are not capable of being modified or customized by users, thereby limiting the information that may be obtained from the digital twin to those use cases approved or created by the entity, rather than the ultimate end users of the digital twin platform. Thus, while digital twins have shown promise as a tool for evaluating real world designs, the above-described drawbacks have limited the benefits that may be realized by using digital twins.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus for wireless communication at a vehicle, comprises: one or more sensors; at least one processor; and a memory coupled to the at least one processor, wherein the at least one processor is configured to cause the apparatus to: associate changes in operations of the vehicle with changes in in-vehicle network (IVN) performance and electronic control unit (ECU) performance to generate association data; and provide the association data to a digital twin associated with the vehicle, the association data configured to cause the digital twin to model performance of the vehicle and generate modified operating parameters.

In an additional aspect of the disclosure, a device for wireless communication, comprises: at least one processor; and a memory coupled to the at least one processor, wherein the at least one processor is configured to cause the device to: receive association data associated with a vehicle type generated by an in-vehicle digital twin; evaluate in-vehicle network (IVN) performance and electronic control unit (ECU) performance with adjusted operating parameters using a cloud digital twin associated with the vehicle type and based on the association data; determine one or more modified operating parameters for the vehicle type based on the evaluation of the IVN performance and the ECU performance with the adjusted operating parameters; and provide an update to one or more vehicles associated with the vehicle type based on the one or more determined modified operating parameters.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a network node and a user equipment (UE) according to one or more aspects.

FIG. 3 is a diagram illustrating an example of an enhanced vehicle digital twin system including dual, local and network vehicle digital twins according to one or more aspects.

FIG. 4 is a block diagram illustrating an example wireless communication system that supports enhanced vehicle digital twin operations according to one or more aspects.

FIG. 5 is a block diagram illustrating an example vehicle that supports enhanced vehicle digital twin operations according to one or more aspects.

FIG. 6 is a timing diagram illustrating an example process that supports enhanced vehicle digital twin operations according to one or more aspects.

FIG. 7 is a timing diagram illustrating an example process that supports enhanced vehicle digital twin operations according to one or more aspects.

FIG. 8 is a timing diagram illustrating an example process that supports enhanced vehicle digital twin operations according to one or more aspects.

FIG. 9 is a timing diagram illustrating an example process that supports enhanced vehicle digital twin operations according to one or more aspects.

FIG. 10 is a flow diagram illustrating an example process that supports enhanced vehicle digital twin operations according to one or more aspects.

FIG. 11 is a flow diagram illustrating an example process that supports enhanced vehicle digital twin operations according to one or more aspects.

FIG. 12 is a block diagram of an example vehicle that supports enhanced vehicle digital twin operations according to one or more aspects.

FIG. 13 is a block diagram of an example wireless communication device that supports enhanced vehicle digital twin operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Vehicles are being designed to include advanced wireless communication systems and may correspond to user devices that interact with wireless networks and directly with other user devices. For example, vehicles may include one or more wireless communication systems, such as cellular communication system, Wi-Fi and Bluetooth communication systems, and Vehicle-to-everything (V2X) communication systems. Additionally, in-vehicle wired networks are complex, using multiple, disparate standards and physical wire types, such as CAN, LIN, FlexRay, Ethernet, MOST, etc., for communication to a large number of vehicle sensors and ECUs, contributing to vehicle design, manufacture and maintenance complexity and cost. Designing, managing and maintaining these communication systems, and the vehicle in general, is a complex and costly process.

In an effort to simply the complex wired and wireless networks of current and future vehicles, we propose to use a digital twin to model network and vehicle behavior to improve various aspects associated with the vehicle, from vehicle design to vehicle operation. However, many challenges exist in utilizing digital twins. Apart from challenges with establishing a digital twin which can accurately model a complex real world system, such as a car, with many disparate subsystems that may affect each other, accurately modeling the real world system, e.g., a vehicle, during real world use and updating the digital twin for real world use that may also be affected by different operating conditions and wear and tear poses many challenges. Currently, digital twins suffer from insufficient data and incomplete modeling of all the possible situations a system like vehicle may experience and they suffer from a lack of real-time data or feedback for operations and changes to the system. For example, current network planning use digital tools for offline simulations or small-scale trial operations, resulting in a long network deployment cycle and low efficiency. As another example, existing network planning and operation tools are typically generated offline and not real-time. The assessment of deployed networks is not continuous and therefore, dynamic aspect changes may not be capture or acted upon.

As described herein, digital twins are used for in-vehicle networks IVNs, including wired and wireless networks, of vehicles to improve operations of the IVNs and the vehicles themselves. Additionally, methods and systems are described to enable real-time data capture and updating of digital twins over the life and operation of the vehicle to solve the above challenges and problems and also to improve the accuracy of the digital twin and optimize the performance of the vehicle an IVN.

Various aspects describe herein relate generally to vehicle IVNs and digital twins and more particularly to real-time digital twin data capture for updating digital twins and using dual instances of a vehicle digital twin to enable increased updating of each other via wireless communication. Some aspects more specifically relate to data association of vehicle operation data with IVN performance data to generate real-time digital twin input data, also referred to as association data, for improving and updating the vehicle digital twin. In some examples, a vehicle with sensors for its IVNs may generate sensor data of IVN performance and associate or correlate such performance with vehicle operations data indicating a state of operation of the vehicle and its environment or scenario in which it is operating. The association data may be used as or to identify real-time digital twin input data for the vehicle digital twin. The use of real-time digital twin input data from actual vehicle operation over the life of the vehicle enables the digital twin to more accurately capture vehicle performance over the life of the vehicle, including changes due to modifications and to wear and tear on the vehicle.

In some examples, additional sensors and/or data buffers may be employed to capture additional real-time performance data for the digital twin, such as IVN noise information, and to enable digital twin resource usage to be reduce or paused during high usage or critical vehicle operations.

In some aspects, a vehicle may share a portion of its real-time digital twin input data, e.g., association data) with other vehicles and network devices. For example, the vehicle may transmit wireless communications to other vehicles directly or indirectly via network devices to share its captured input data for local vehicle digital twins, and may also transmit wireless communications to the network to share its captured input data to enable network side versions or instances of vehicle digital twins.

In some aspects, a vehicle may share digital twin updates determined from its real-time digital twin input data (e.g., association data) with other vehicles and network devices. For example, the vehicle may transmit wireless communications to other vehicles directly or indirectly via network devices to share its determined digital twin updates for local vehicle digital twins, and may also transmit wireless communications to the network to share its determined digital twin updates for network side versions or instances vehicle digital twins.

In some aspects, a vehicle may share vehicle updates determined from its real-time digital twin input data (e.g., association data) and/or digital twin updates with other vehicles and network devices. For example, the vehicle may transmit wireless communications to other vehicles directly or indirectly via network devices to share its determined vehicle updates with one or more other similar vehicles, and may also transmit wireless communications to the network to share its determined vehicle updates for network side distribution and/or additional digital twin updates.

In some examples, a vehicle may offload the above described digital twin data related processing and/or wireless communication of digital twin data to other types of UEs. For example, a vehicle may offload some digital twin related data processing or communications to UEs to leverage wireless communication links and/or system resources of the UEs.

In some aspects, a vehicle may receive digital twin updates determined from its real-time digital twin input data (e.g., association data) with other vehicles and network devices. For example, the vehicle may receive wireless communications from other vehicles directly or indirectly via network devices to receive additional digital twin updates determined by one or more other similar vehicles, and may also receive wireless communications from the network with network-determined digital twin updates.

In some aspects, a vehicle may receive vehicle updates determined from its real-time digital twin input data (e.g., association data) and/or digital twin updates with other vehicles and network device. For example, the vehicle may receive wireless communications from other vehicles directly or indirectly via network devices to receive additional vehicle updates determined by one or more other similar vehicles, and may also receive wireless communications from the network with network-determined vehicle updates.

In some examples, the enhanced digital twin system may include a distributed architecture with regional or edge servers or base stations that are also capable of performing network side operations, in addition to other core network or cloud based servers that also perform network side digital twin operations. The regional or edge servers or base stations may be configured to receive an aggregate regional digital twin data for relay to a core or centralized server or device, to enable multiple layers or digital twins, such as regional and continental/global digital twins.

In some aspects, a network or operator may design new or future vehicles based on the above digital twin related data and updates shared with the network by one or more vehicles. For example, a network operator or vehicle manufacturer may utilize the received real-time performance data and/or the digital twin or vehicle updates generated therefrom to design new vehicles, such as new IVNs for future vehicles and even operating parameters for the new designs.

Particular aspects of the subject matter described in the disclosure can be implemented to realize one or more of the following advantages. In some examples, by employing real-time vehicle operations and IVN and/or ECU performance data capture and data association operations, high quality real-time digital twin input data can be generated to enable the automatic update of the vehicle digital twin over the life of the vehicle as well as some of the other aspects and advantages described below. The creation of real-time digital twin input data from actual vehicle operation over the life of the vehicle solves some of the current challenges and issues with maintaining accurate digital twins for systems which may operate in different environments and to account for system changes over time.

In some examples, by using IVN noise sensors additional IVN performance information can be obtained for association with different vehicle operations and input into the digital twin. This additional IVN performance data may improve the accuracy of the digital twin modeling and vehicle updates generated based on the digital twin modeling. By using dedicated digital twin related ECU data buffers digital twin resource usage may be able to be reduced or paused during vehicle operations which may require such resources. Accordingly, the vehicle may have lower costs and complexity in design through less peak or total resource capability needed and the digital twin system may not reduce the effectiveness of mission critical systems, such as automated collision detection or self-driving.

In some examples, additional sensors and/or data buffers may be employed to capture additional real-time performance data for the digital twin, such as IVN noise information, and to enable digital twin resource usage to be reduce or paused during high usage or critical vehicle operations.

In some examples, engaging in vehicle-side or vehicle-generated digital twin updates, the digital twin updates can be based on real-time digital twin input data from the actual vehicle and can be used to automatically update the vehicle digital twin and vehicle's operations over the life of the vehicle to account for changes in the vehicle and environment. The digital twin updates may be more accurate than using input data or updates from other devices, such as test devices or devices that experience different conditions, as the data accounts for the specific configuration and condition of the vehicle and of its operating environment(s).

In some examples, by engaging in vehicle-side or vehicle-generated vehicle updates, the vehicle updates can be based on real-time digital twin input data from the actual vehicle or digital twin update from the actual vehicle and can be used to automatically update the vehicle's operations over the life of the vehicle to account for changes in the vehicle and environment. The vehicle updates may be more accurate than using input data or updates from other devices, such as test devices or devices that experience different conditions, as the data accounts for the specific configuration and condition of the vehicle and of its operating environment(s).

In some examples, engaging in network-side or network-generated digital twin updates, the digital twin updates can be based on digital twin input data and/or digital twin updates from multiple vehicles, including vehicles of different type, regions, groups etc. The digital twin updates may be more accurate and more robust as compared to local or device level digital twin updates through their determination based on more real-time input data for more operating scenarios.

In some examples, by engaging in network-side or network-generated vehicle updates, the vehicle updates can be based on digital twin input data and/or digital twin updates from multiple vehicles, including vehicles of different type, regions, groups etc. The vehicle updates may be more accurate and more robust as compared to local or device level vehicle updates through their determination based on more real-time input data for more operating scenarios.

In some examples, by utilizing a distributed network architecture with regional or edge servers or base stations that have enhanced digital twin capabilities, the system may enable more tailored and more accurate updates on a regional level, and may reduce data transfer costs and data privacy issues.

In some examples, by designing new or future vehicles based on the above digital twin related data and updates shared with the network by one or more vehicles, a design entity may have reduced design costs and overhead and the new or future vehicles may have improved performance and reliability as compared to current designs by the reduction of issues and noise/interferences of the current designs.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz - 7.125 GHz) and FR2 (24.25 GHz - 52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

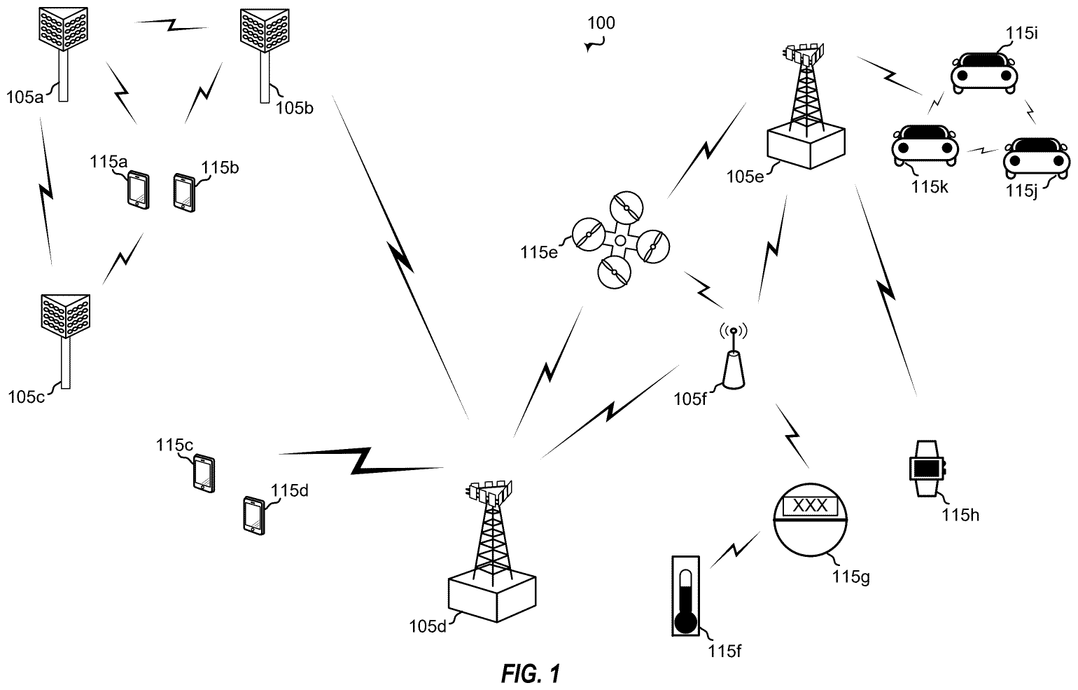

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of network nodes 105 and other network entities. A network node (e.g., base station) may communicate with the UEs and may also be referred to as an evolved node B (eNB), a next generation eNB (gNB), an access point, and the like. Each network node 105 may provide communication coverage for a particular geographic area. In 3GPP, the term “cell” may refer to this particular geographic coverage area of a network node (e.g., a base station or a base station subsystem) serving the coverage area, depending on the context in which the term is used. In implementations of wireless network 100 herein, network nodes 105 may be associated with a same operator or different operators (e.g., wireless network 100 may include a plurality of operator wireless networks). Additionally, in implementations of wireless network 100 herein, network node 105 may provide wireless communications using one or more of the same frequencies (e.g., one or more frequency bands in licensed spectrum, unlicensed spectrum, or a combination thereof) as a neighboring cell. In some examples, an individual network node 105 or UE 115 may be operated by more than one network operating entity. In some other examples, each network node 105 and UE 115 may be operated by a single network operating entity.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100. The UEs may include one or more V2X infrastructure devices, such as UEs associated with vehicles and vehicle infrastructure. The UEs associated with vehicles may include vehicle UEs (e.g., a UE integrated with an automobile) and UEs located inside of a vehicle.

A mobile apparatus, such as UEs 115, may be able to communicate with any type of the network nodes, whether V2X infrastructure (e.g., roadside unit (RSU), vulnerable road user (VRU) device, traffic light), macro base stations, pico base stations, femto base stations, relays, and the like. In FIG. 1, a communication link (represented as a lightning bolt) indicates wireless transmissions between a UE and a serving network node, which may be a base station designated to serve the UE on the downlink or uplink, or desired transmission between base stations, and backhaul transmissions between base stations. UEs may operate as base stations or other network nodes in some scenarios. Backhaul communication between network nodes of wireless network 100 may occur using wired or wireless communication links.

In operation at wireless network 100, network nodes 105a-105c serve UEs 115a and 115b using 3D beamforming and coordinated spatial techniques, such as coordinated multipoint (CoMP) or multi-connectivity. Macro base station 105d performs backhaul communications with network nodes 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

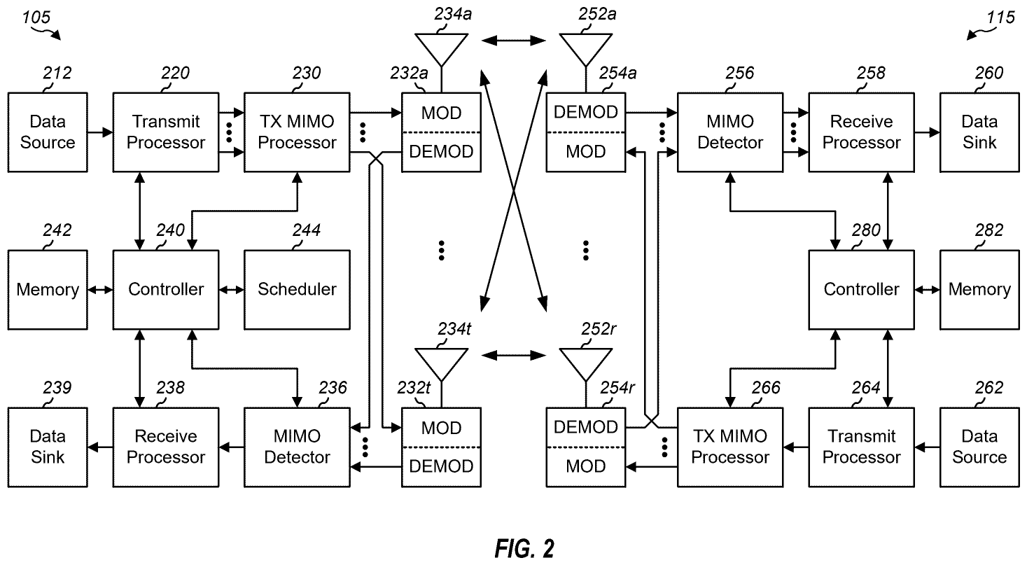

FIG. 2 is a block diagram illustrating examples of network node 105 and UE 115 according to one or more aspects. Network node 105 and UE 115 may be any of the base stations and one of the UEs in FIG. 1. For a restricted association scenario (as mentioned above), network node 105 may be small cell base station 105f in FIG. 1, and UE 115 may be UE 115c or 115d operating in a service area of base station 105f, which in order to access small cell base station 105f, would be included in a list of accessible UEs for small cell base station 105f. Network node 105 may also be a base station of some other type. As shown in FIG. 2, network node 105 may be equipped with antennas 234a through 234t, and UE 115 may be equipped with antennas 252a through 252r for facilitating wireless communications.

At network node 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from network node 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to network node 105. At network node 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

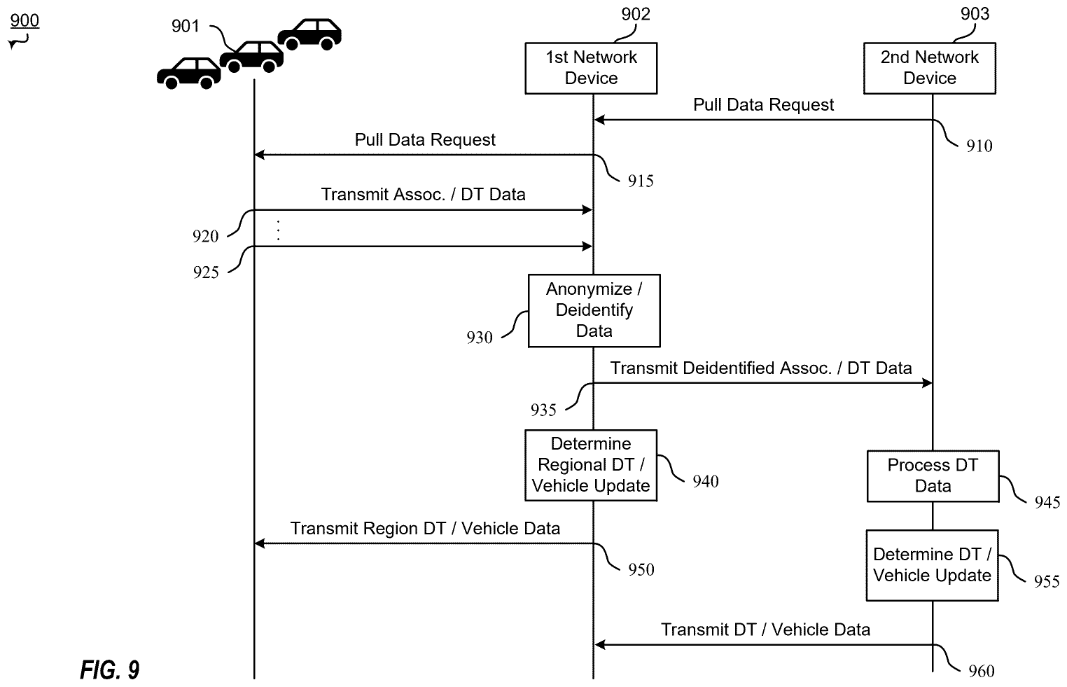

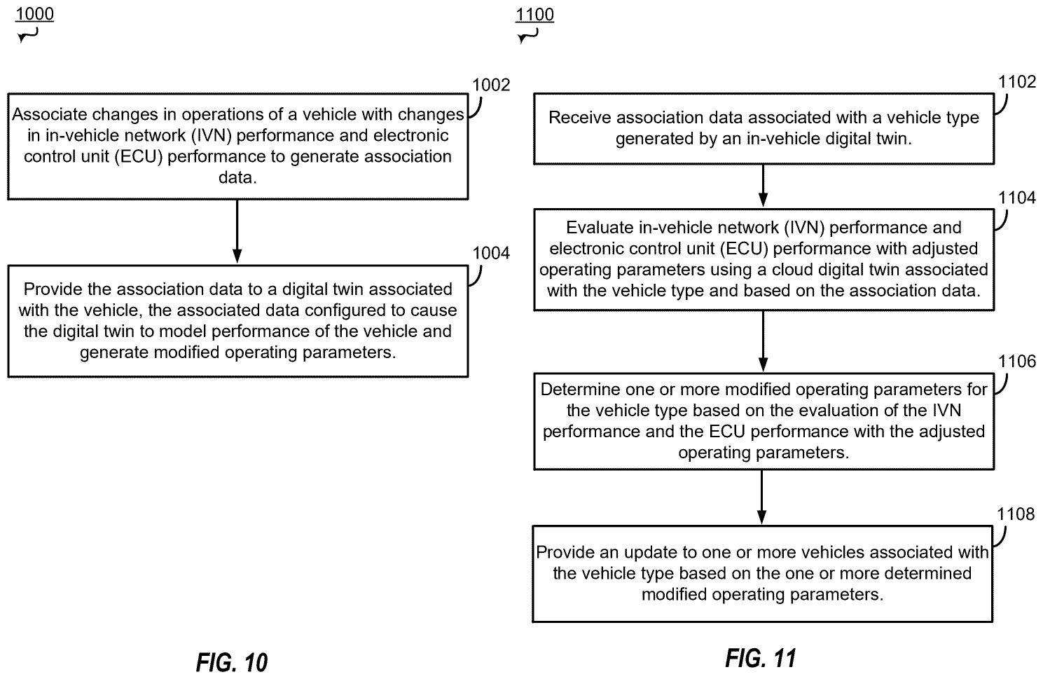

Controllers 240 and 280 may direct the operation at network node 105 and UE 115, respectively. Controller 240 or other processors and modules at network node 105 or controller 280 or other processors and modules at UE 115 may perform or direct the execution of various processes for the techniques described herein, such as to perform or direct the execution illustrated in FIGS. 9 and 10, or other processes for the techniques described herein. Memories 242 and 282 may store data and program codes for network node 105 and UE 115, respectively. Scheduler 244 may schedule UEs for data transmission on the downlink or the uplink.

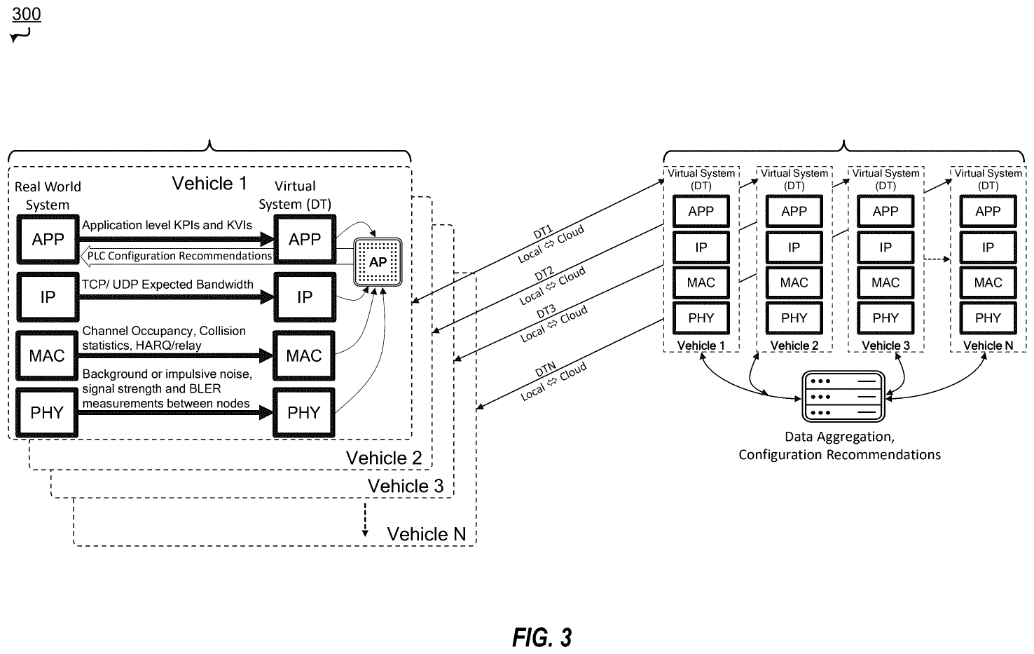

FIG. 3 illustrates a diagram 300 illustrating an example of an enhanced vehicle digital twin system including dual, local and network vehicle digital twins. The enhanced vehicle digital twin system of FIG. 3 may include or correspond to the wireless network 100 of FIG. 1 and may include one or more network nodes and one or more UEs, such as vehicles or vehicle UEs, as described with reference to FIG. 1. For example, the devices of the enhanced vehicle digital twin system of FIG. 3 may be part of and communicate via the wireless network 100 of FIG. 1.

As illustrated in the example of FIG. 3, the enhanced vehicle digital twin system includes a plurality of vehicles, Vehicles 1-N, each including a local digital twin corresponding to a digital twin of the vehicle, such as of the IVN thereof, and the enhanced vehicle digital twin system includes a network entity including one or more network or cloud-based vehicle digital twins for or associated with the Vehicles 1-N. The digital twin may represent and/or simulate the real world performance of the vehicle, including the IVN thereof.

In the example of FIG. 3, the network entity includes a network digital twin for each vehicle, Vehicle 1-N, and includes a master or global digital twin for one or more vehicles, such as master digital twin for one or more vehicle types or groups of vehicles (e.g., vehicles within a particular locality or region). For example, the network entity may include a network copy or instance of the digital twin of each vehicle in some implementations. Additionally, or alternatively, the network entity may include a digital twin for each type of vehicle (e.g., each make and model, or for variants of a make and model, such as a particular trim level or option package).

During operation of the enhanced vehicle digital twin system, each instance of the digital twin may be used to model different parameters of the IVNs of the Vehicles 1-N for different vehicle operations or conditions. The different parameters may include application layer parameters, IP layer parameters, MAC layer parameters, physical layer parameters, or a combination thereof. The vehicle operations or conditions may include different operational states of the vehicle and different road, weather, and location conditions, or combinations thereof. As the Vehicles 1-N are operating in different conditions and with different states, the Vehicles 1-N intake different data and model different situations. Each digital twin may use this data to improve IVN performance for the corresponding vehicle for current modes and/or generate new modes. The Vehicles 1-N may then generate updates (e.g., update data) for the digital twin to reflect the improved or new IVN performance and to reflect changes to the system. The Vehicles 1-N and network may then exchange this digital twin update data between each other to improve the digital twins and performance of each vehicle.

As illustrated in the example of FIG. 3, the Vehicles 1-N may transmit communications to a network entity, such as a network node (e.g., network node 105). The Vehicles 1-N may also transmit communications between each other. Such communications may include as device-to-device (D2D) communications or vehicle-to-everything (V2X) communications or UL/DL communications with a base station or edge server. The communications with the base station or edge server may be routed or relayed to the network entity when the network entity is not a base station or edge server, such as separate cloud server or core network device.

Accordingly, the enhanced vehicle digital twin system of FIG. 3 enables vehicle digital twins to use real-time digital twin input data from vehicle operations and digital twin updates over the life of the vehicle enabling long term use of the digital twin without manual updates and intervention for system changes. Additionally, the enhanced vehicle digital twin system of FIG. 3 further enables the vehicle to share the benefits that are provided from the real-time digital twin input data by enabling wireless communication of update transmissions between devices and/or the network and by the use of a network side instance or version of vehicle digital twin and/or a master version of a vehicle digital twin which can be used to consolidate digital twin updates and facilitate the digital twin updates to more vehicles.

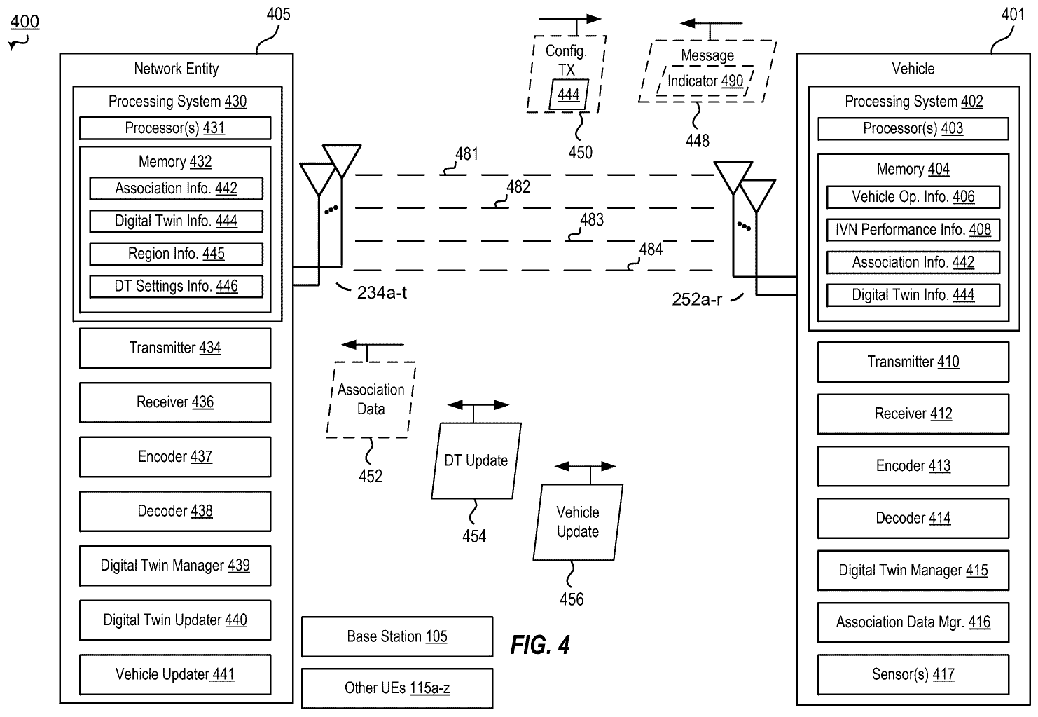

FIG. 4 illustrates an example of a wireless communications system 400 that supports enhanced vehicle digital twin operations in accordance with aspects of the present disclosure. In some examples, wireless communications system 400 may implement aspects of wireless network 100. For example, wireless communications system 400 may include a network, such as one or more network entities (e.g., network entity 405) and one or more UEs (e.g., UEs 115a-z and vehicle 401. Enhanced vehicle digital twin operations may improve vehicle IVN network performance and performance of the vehicle overall. For example, the IVN network performance may experience reduced interference and errors due to IVN performance adjustments or optimizations for a broader range of vehicle operations. Accordingly, vehicle and IVN device performance can be increased. Additionally, the improved vehicle performance, such as improved wireless communication performance thereof, may improve wireless network performance and experience as well.

UEs 115a-z, vehicle 401, and network entity 405 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. UEs 115a-z, vehicle 401, and network entity 405 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as beam management or BWP switching functionality. In some implementations, two or more CCs are quasi co-located, such that the CCs have the same beam and/or same symbol.

In some implementations, control information may be communicated via vehicle 401, network entity 405, and UE 115. For example, the control information may be communicated using MAC-CE transmissions, RRC transmissions, DCI (downlink control information) transmissions, UCI (uplink control information) transmissions, SCI (sidelink control information) transmissions, another transmission, or a combination thereof.

UEs 115a-z and vehicle 401 can include a variety of components (e.g., structural, hardware components) used for carrying out one or more functions described herein. For example, these components can include a processing system 402, transmitter 410, receiver 412, encoder, 413, decoder 414, digital twin manager 415, association data manager 416, sensors 417, and antennas 252a-r. The description below will be explained with reference to vehicle 401.

The processing system 402 includes one or more processors and one or more memories, such as processor(s) 403 and memory 404. Each processor and memory may include corresponding circuitry, such as processor circuitry and memory circuitry. The processing system 402 is configured to cause the vehicle 401 (or one or more components thereof, such as apparatus for communication at the vehicle 401) to perform the operations described herein. For example, one or more processors of processor(s) 403 may be configured to execute instructions stored at memory 404 to perform the operations described herein. In some implementations, processing system 402, such as one or more processors 403 thereof, includes or corresponds to controller/processor 280, and memory 404 includes or corresponds to memory 282. Memory 404 may also be configured to store vehicle operations information 406, IVN performance information 408, association information 442, digital twin information 444, or a combination thereof, as further described herein.

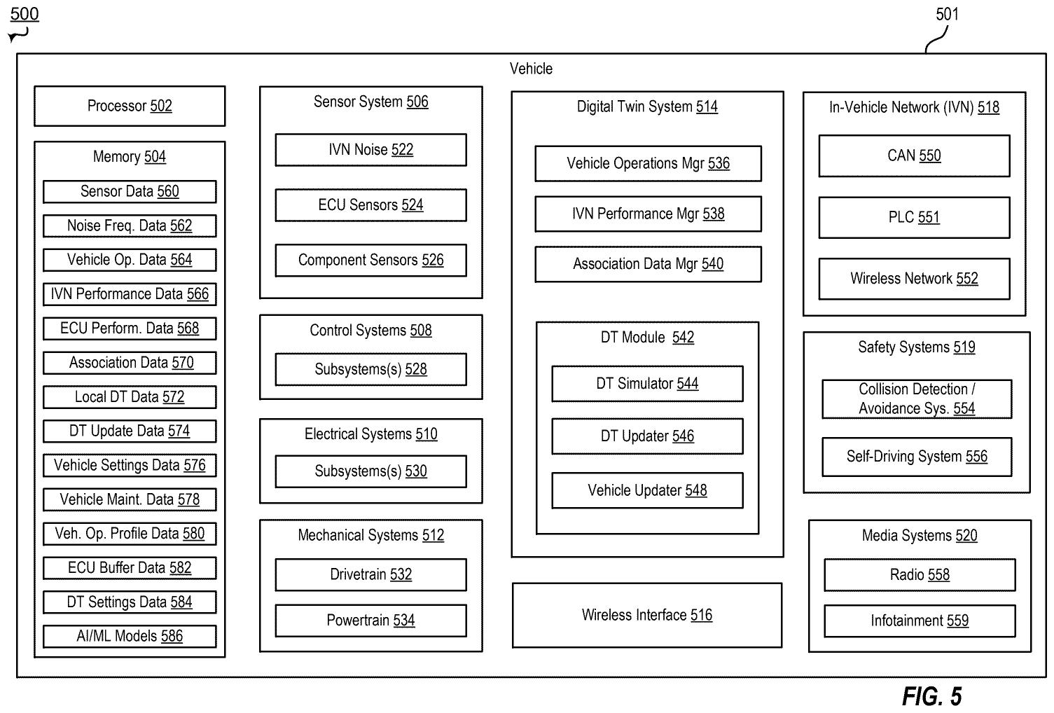

The vehicle operations information 406 (e.g., vehicle operations data) includes or corresponds to data associated with states of operation of the vehicle 401 and/or components thereof. For example, the vehicle operations information 406 may include data indicating an operational mode of the vehicle 401 overall (e.g., normal driving mode, summer driving mode, winter driving mode, towing mode, parked, idle, etc.) or of one or more components thereof, such as the engine, transmission, windows, windshield wipers, HVAC system, turbo system, suspension system, brakes, shocks, radio, wireless communication system, media system, etc. As illustrative, non-limiting examples of states of components of the vehicle 401, a transmission may indicate gear states, an engine may indicate RPM values or categories, a turbo may indicate active, inactive or boost level, and other systems may indicate on/off. The vehicle operations information 406 (e.g., vehicle operations data) may include or correspond to data received from one or more sensors (e.g., sensors 417) of or associated with the vehicle 401, one or more component controllers, and/or one or more ECUs of the vehicle 401. The sensors may include additional or new dedicated frequency and noise sensors for various wired networks of the IVN, as described further with reference to FIG. 5. Additionally, or alternatively, a digital twin device or dedicated ECU may receive sensor data and/or controller data and may generate the vehicle operations information 406 based on the received data.

The IVN performance information 408 (e.g., IVN performance data) includes or corresponds to data associated with or corresponding to performance of the IVN of the vehicle 401. For example, the IVN performance information 408 may include information about or regarding the overall performance of the IVN of the vehicle 401. As illustrative, non-limiting examples of IVN performance information 408 of the vehicle 401, the IVN performance information 408 may include one or more of measured noise, interference sources, throughput, bandwidth availability, MCS, packet loss, packet error rate, forward error correction (FEC) information, power line communication (PLC) traffic, PLC noise profile information, repetition rate, etc. The IVN performance information 408 may include or correspond to data received from one or more sensors of or associated with the IVN of the vehicle 401, one or more component controllers, and/or one or more ECUs of the vehicle 401.

In some implementations, the IVN performance information 408 may include ECU performance information. For example, the IVN performance information 408 may include information regarding performance of one or more ECUs of the vehicle 401, such as ECUs associated with and not associated with the IVN of the vehicle 401. In other implementations, the vehicle 401 further includes ECU performance information separate from the IVN performance information 408. As illustrative, non-limiting examples of ECU performance information of the vehicle 401, the ECU performance information may include one or more of temperature information, accelerometer information, driving conditions/ride mode information, ride height information, vibration information, gearing ratio information, etc.

The association information 442 includes or corresponds to data which links or associates the vehicle operations information 406 with the IVN performance information 408. For example, the association information 442 may include or correspond a database or data structure which enables the linked storage of the vehicle operations information 406 with the IVN performance information 408. As another example, the association information 442 may include or correspond to tag information, timestamps or other identifiers which links the vehicle operations information 406 with the IVN performance information 408 and enables the digital twin to use the vehicle operations information 406 and the IVN performance information 408 for modeling and simulating performance of the vehicle 401.

The digital twin information 444 includes or corresponds to data associated with enhanced vehicle digital twin operations. The digital twin information 444 may include or correspond to local digital twin information representing a model of the IVN of the vehicle 401 and other components and systems of the vehicle 401. The digital twin information 444 may also include digital twin update information, digital twin version information, region information, or a combination thereof. In some implementations, digital twin update information includes one or more modified operating parameters for the vehicle, such as one or more modified operating parameters for the IVN of the vehicle 401. As illustrative, non-limiting examples of modified operating parameters of the IVN of the vehicle 401, the modified operating parameters may include application level parameters, IP level parameters, MAC level parameters, Physical layer parameters, or a combination thereof. As illustrative, non-limiting examples of parameters of the different levels or layers, the application level parameters may include KPI's, KVI's, and PLC configuration recommendations, the IP level parameters may include TCP and UDP expected bandwidth, throughput, packet loss, and an amount of repetitions, the MAC level parameters may include Channel occupancy, collision statistics, HARQ and relay property information, and an amount of repetitions, and the physical level parameters may include one or more of background or impulsive noise, signal strength, BLER, node measurements, SNR, SINR, receive power, transmit power, Modulation and Coding, Channel Estimation and Adaptation, or MIMO Transmission features.

The digital twin information 444 may further include digital twin settings information on one or more types of enhanced digital twin operational modes and/or thresholds or conditions for switching between enhanced digital twin operational modes and/or configurations thereof. For example, the digital twin settings information may have data indicating different thresholds and/or conditions for different digital twin operational modes, such as sidelink modes, UL/DL modes, relay modes, regional modes, etc., or a combination thereof.

The sensor information data includes or corresponds to data associated with or corresponding to information received from one or more sensors, such as sensors 417, of or associated with the vehicle 401. For example, the sensor information may include measurement information or data generated by the sensors, such as sensor data. The sensor information may also include state data indicating one or more identified or detected states of the vehicle 401 or components thereof indicated by or derived from the sensor data (e.g., measurement values).

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, vehicle 401 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. Digital twin manager 415 (e.g., DT manager) may be configured to perform enhanced vehicle digital twin operations. For example, the digital twin manager 415 may be configured to generate digital twin updates, such as digital twin update data. To illustrate, the digital twin manager 415 may use the association data in the digital twin to model additional scenarios or operations, and the digital twin manager 415 may determine updates to the digital twin to more accurately reflect vehicle operation or to update the digital twin for received vehicles and/or digital twin updates from the network or other vehicles based on the modeling (e.g., simulations of different IVN operating parameters during different vehicle operating conditions). The association data may enable the digital twin manager 415 to identify the IVN performance data to use to model IVN performance that corresponds with the vehicle operations being modeled or simulated based on the vehicle operations data.

As another example, the digital twin manager 415 may be configured to generate vehicle updates, such as vehicle update data. For example, the digital twin manager 415 may determine additional or modified operation parameters for the IVN for different vehicle operating parameters based on the updated digital twin data and the association data.

Additionally, the digital twin manager 415 may be configured to control or coordinate digital twin update communications, such as transmitting and receiving vehicle digital twin notifications with or indicating association data, digital twin updates, and/or vehicle updates. For example, vehicle digital twin manager 415 may be configured to determine whether to send vehicle digital twin messages and what to include in the vehicle digital twin message. To illustrate, the vehicle digital twin manager 415 may determine how to respond to vehicle digital twin message. In some such implementations, the vehicle digital twin manager 415 may be configured to determine whether to respond to received vehicle digital twin messages and/or what actions to perform based on received vehicle digital twin messages. In some implementations, the vehicle digital twin manager 415 determines resources for vehicle digital twin transmissions. For example, the vehicle digital twin manager 415 may determine available transmission resources from signaling messages and/or channel/medium sensing.

Association data manager 416 may be configured to generate and/or process association data. For example, the association data manager 416 may generate or collect the vehicle operations data and/or IVN performance data and associate the operations and performance data to generate the association data. To illustrate, the association data manager 416 may link the vehicle operations information 406 with the IVN performance information 408, such as with tags, timestamps, or other identifiers, or may generate a data structure or database that includes the vehicle operations information 406 and IVN performance information 408 associated with one another. The digital twin manager 415 may then use the association data in the digital twin to model additional scenarios or operations as described above. In some implementations, the association data manager 416 may be part of the digital twin manager 415.

The sensors 417 may include a plurality of sensors, including sensors of different types. As illustrative, non-limiting examples, the sensors 417 include one or more of component sensors, noise sensors, traffic sensors, ECU sensors, acceleration sensors, vibration sensors, humidity sensors, light sensors, RF sensors, RADAR sensors, LIDAR sensors, etc.

Network entity 405 includes processing system 430, transmitter 434, receiver 436, encoder 437, decoder 438, digital twin manager 439, digital twin updater 440, vehicle updater 441, and antennas 234a-t. The processing system 402 includes one or more processors and one or more memories, such as processor(s) 431 and memory 432. The processing system 430 is configured to cause the network entity 405 to perform the operations described herein. For example, one or more processors of processor(s) 431 may be configured to execute instructions stored at memory 432 to perform the operations described herein. In some implementations, processing system 430 includes or corresponds to controller/processor 240, and memory 432 includes or corresponds to memory 242. Memory 432 may be configured to store association information 442, digital twin information 444, region information 445, digital twin settings information 446 (e.g., DT settings information), or a combination thereof, similar to the vehicle 401 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver 436 may include or correspond to one or more components of network node 105 or UE 115 described with reference to FIG. 2.

Encoder 437 and decoder 438 may include the same functionality as described with reference to encoder 413 and decoder 414, respectively. Digital twin manager 439 may include similar functionality as described with reference to digital twin manager 415. For example, the digital twin manager 439 may be configured to perform vehicle digital twin operations. Digital twin updater 440 may also include similar functionality as described with reference to digital twin manager 415. For example, the digital twin updater 440 may be configured to manage and update the network or cloud based digital twins (e.g., the network side instance or instances) for all of the different vehicles and/or vehicles type based on received association data and/or digital twin updates, and optionally based on vehicle updates. Vehicle updater 441 may be configured to determine vehicle updates for one or more vehicles (e.g., modified IVN operating parameters) and to determine new vehicle designs and new vehicle operational modes and maintenance profiles. For example, the vehicle updater 441 (e.g., vehicle designer) may leverage aggregated information from multiple vehicle digital twins to design new IVN networks and/or operating parameters thereof and/or to generate new driving modes or maintenance profiles, as described further with reference to FIGS. 5-9.

During operation of wireless communications system 400, the network (e.g., network entity 405 and/or associated vehicles and UE devices) may determine that vehicle 401 has enhanced vehicle digital twin capability. For example, vehicle 401 and/or a UE may transmit a message 448 that includes an enhanced vehicle digital twin indicator 490 (e.g., an object-based location and/or range capability indicator). Indicator 490 may indicate enhanced vehicle digital twin capability for one or more digital twin or communication modes, such as sidelink, V2X, downlink/uplink, relay, regional, etc. In some implementations, a network entity (e.g., the network entity 405) sends control information to indicate to vehicle 401 that enhanced vehicle digital twin operation and/or a particular type of enhanced vehicle digital twin operation is to be used. For example, in some implementations, configuration transmission 450 is transmitted to the vehicle 401. The configuration transmission 450 may include or indicate to use enhanced vehicle digital twin operations or to adjust or implement a setting of a particular type of enhanced vehicle digital twin operation. For example, the configuration transmission 450 may include vehicle digital twin settings or configuration information, and/or the digital twin data itself.

During operation, devices of wireless communications system 400, perform enhanced vehicle digital twin operations. For example, the vehicle 401 and the network entity 405 may communicate transmissions which enable updating of the local and network-based digital twins for the vehicle 401, as illustrated in the example of FIG. 4. This enhanced vehicle digital twin capability and flexibility enables vehicles to operate with more advanced and accurate vehicle digital twins, which enables more accurate digital twin modeling and simulation performance. The more accurate digital twin modeling and simulations performance may indicate improved operating parameters for an IVN of the vehicle 401, which improves vehicle and wireless network operations.

In the example of FIG. 4, the vehicle 401 optionally transmits an association data transmission 452 to the network entity 405. For example, the vehicle 401 transmits an uplink transmission to the network entity 405 directly or via a base station including the association information 442. As another example, the vehicle 401 transmits a sidelink transmission to the UE 115 via a sidelink channel including the association information 442 for relay to the network entity 405. The association data transmission 452 or the association information 442 thereof may indicate or be generated based on the vehicle operations information 406 and/or the IVN performance information 408. To illustrate, the association data transmission 452 is generated based on performance of associating the vehicle operations information 406 with the IVN performance information 408 and/or ECU performance information. The association data transmission 452 may include portions (or all) of the vehicle operations information 406 and/or the IVN performance information 408, and data (e.g., association information 442) linking the pieces or portions of the vehicle operations information 406 and the IVN performance information 408 together.

The network entity 405 receives the association data transmission 452, including the association information 442 thereof. The network entity 405 optionally transmits feedback for the association data transmission 452. The network entity 405 may use the association data transmission 452, such as the association information 442 thereof, to update its own, network based digital twin or digital twin instance for the vehicle 401. For example, the network entity 405 may use the additional vehicle operations information 406 and the IVN performance information 408 which correspond to each other as indicated by the association information 442 from the vehicle 401 in modeling and simulating performance of the vehicle 401 itself or for a type or group of vehicle associated with the vehicle 401. The network based digital twin may include or correspond to specific digital twin instance for the vehicle 401 or a general digital twin instance for a type of the vehicle 401.

In some implementations, the network entity 405 generates and transmits a digital twin update transmission 456 to the vehicle 401. For example, the network entity 405 generates a digital twin update based on the received association data transmission 452 and/or based on received association data or digital twin updates from other devices, as further described with refence to FIGS. 5-9. To illustrate, the network entity 405 processes the association data and uses the digital twin to model or simulate vehicle IVN performance with different parameters during different operating scenarios. The modeling may result in new or improved IVN operating parameters for select operating scenarios or combinations. The network entity 405 may update the digital twin and/or vehicle settings based on the identified new or improved IVN operating parameters for select operating scenarios or combinations. The network entity 405 may transmit digital twin update data to the vehicle 401 directly or indirectly to update the local digital twin of the vehicle 401.

Additionally, or alternatively, the vehicle 401 generates and transmits a digital twin update transmission 456 to the network entity 405. For example, the vehicle 401 may also or alternatively use the association data generated by the vehicle 401, similar to as described above with reference to the network entity 405, to model or simulate vehicle IVN performance with different parameters during different operating scenarios and identify new or improved IVN operating parameters for select operating scenarios or combinations. In such implementations, the vehicle 401 may transmit digital twin update data to the network entity 405 directly or indirectly to update the network digital twin for or associated with the vehicle 401.

In addition to or in the alternative of providing digital twin updates, the vehicle 401 and/or network, such as network entity 405, may provide vehicle updates to each other. The vehicle updates may be sent prior to or after the digital twin updates when both are sent. In some such implementation, one device may send one type of update and another device may send another type of update. For example, the vehicle 401 may send a digital twin update and the network (e.g., network entity 405) may send a vehicle update based on the digital twin update, or vice versa.

In some implementations, the network entity 405 generates and transmits a vehicle update transmission 456 to the vehicle 401. For example, the network entity 405 generates vehicle update data based on the updated network digital twin, which was updated based on the association data or digital twin update data received from the vehicle 401 and optionally other vehicles, as further described with refence to FIGS. 5-9. To illustrate, the network entity 405 uses the digital twin to model or simulate vehicle IVN performance with different parameters during different operating scenarios and identify new or improved IVN operating parameters for select operating scenarios or combinations. The network entity 405 may update vehicle operational mode settings/profiles and/or vehicle maintenance profiles based on the identified new or improved IVN operating parameters for select operating scenarios or combinations. The network entity 405 may transmit vehicle update data to the vehicle 401 directly or indirectly to update the local digital twin of the vehicle 401. The network entity 405 may also transmit (e.g., distribute) the vehicle update data to one or more other vehicles to proliferate the update to a larger group, region or type of vehicle to update the local digital twins of the other vehicles.

Additionally, or alternatively, the vehicle 401 generates and transmits a vehicle update transmission 456 to the network entity 405. For example, the vehicle 401 generates vehicle update data based on the updated network digital twin, which was updated based on the association data and/or digital twin update data received from the network entity, as further described with refence to FIGS. 5-9. To illustrate, the vehicle 401 uses the digital twin to model or simulate vehicle IVN performance with different parameters during different operating scenarios and identify new or improved IVN operating parameters for select operating scenarios or combinations. The vehicle 401 may update vehicle operational mode settings/profiles and/or vehicle maintenance profiles based on the identified new or improved IVN operating parameters for select operating scenarios or combinations. The vehicle 401 may transmit vehicle update data to the network entity 405 directly or indirectly to update the local digital twin of the network entity 405. The vehicle 401 may also transmit (e.g., distribute) the vehicle update data directly to one or more other vehicles to proliferate the update to a larger group, region or type of vehicle to update the local digital twins of the other vehicles.

Accordingly, the network (e.g., the network entity 405 and the vehicle 401) may be able to perform vehicle digital twin updates to more efficiently and effectively use vehicle digital twins to more accurately model vehicle IVN performance for a wider range of scenarios, which may improve the efficiency and effectiveness of vehicle IVN and overall network performance.

FIG. 5 illustrates an example 500 of a vehicle 501 that supports enhanced vehicle digital twin operations in accordance with aspects of the present disclosure. In some examples, the vehicle 501 may produce new or updated vehicle operational modes and/or vehicle maintenance profiles for the vehicle 501. The vehicle 501 may include or correspond to any of the vehicles described herein. For example, the vehicle 501 may perform one or more operations of the methods or flows described herein to generate association information and to update a local digital twin of the vehicle 501 based on the association information. This process may include updating a network digital twin for the vehicle based on the association information and/or updated local digital twin of the vehicle 501. As another example, the vehicle 501 may perform one or more operations of the methods or flows described herein to generate vehicle update information and to update the operation of the vehicle based on received digital twin update information for a network and network based digital twin for the vehicle 501. The vehicle 501 may include a processing system with one or more devices or components that perform the enhanced vehicle digital twin operations.

Vehicle 501 may be configured to communicate with one or more sub-systems or devices thereof and/or with one or more external systems or devices. For example, the components and subsystems of vehicle 501 may be configured to communicate with each other via one or more wired or wireless interfaces, often referred to as IVNs or collectively as an IVN. When communicating via a wireless interface internally or externally, the vehicle 501, including one or more sub-systems or devices thereof, may communicate via one or more portions of the electromagnetic spectrum associated with Bluetooth transmissions, Wi-Fi transmissions, or cellular transmissions (including sub-6 GHz and 6 GHz).

Vehicle 501 can include a variety of components (e.g., structural, hardware components) used for carrying out one or more functions described herein. For example, these components can include a processing system and memory configured to perform enhanced vehicle digital twin operations, along with wired and/or wireless communication components, such as a transceiver, an encoder, a decoder, and one or more antennas (not shown in FIG. 5 for simplicity).

The vehicle 501 (e.g., a device or devices thereof) includes one or more processors and one or more corresponding memories. As illustrated in the example of FIG. 5, the vehicle 501 includes a representative processor 502 (e.g., processing system with one or more processors) and a representative memory 504. Processor 502 may be configured to execute instructions stored at memory 504 to perform the operations described herein. In some implementations, processor 502 includes or corresponds to the processing system and/or the processor(s) 403 or 431 of FIG. 3, and memory 304 includes or corresponds to the memory 404 or 432 of FIG. 3. Memory 504 may also be configured to store information and data for enhanced vehicle digital twin operations, vehicle data generation operations, IVN data generation operations, digital twin data association operations, digital twin simulation operations, digital twin update updates, digital twin update notification operations, vehicle update operations, or a combination thereof, as further described herein.

For example, the memory 504 may be configured to store one or more of sensor data 560, noise frequency data 562, vehicle operations data 564, IVN performance data 566, ECU performance data 568, association data 570, local digital twin data 572, digital twin update data 574, vehicle settings data 576, vehicle maintenance profile data 578, vehicle operational profile data 580, ECU buffer data 582, digital twin settings data 584, or AI/ML model data 586.

The sensor data 560 may include or correspond to data indicating measured sensor values for components of the vehicle 501 during operation of the vehicle 501, such as in one or more operational modes or operating scenarios/conditions. The sensor data 560 may be generated by components sensors and/or controllers of the vehicle 501, such as the sensor system 506. The sensor data 560 may include or correspond to the sensor data of FIG. 4.

The noise frequency data 562 may include or correspond to data indicating noise levels and characteristics on wired and/or wireless networks of the IVN of the vehicle 501 during operation of the vehicle 501, such as in one or more operational modes or operating scenarios/conditions. The noise frequency data 562 may be generated by dedicated noise frequency sensors, such as one or more noise frequency sensors of a PLC, a CAN, LIN, and other networks of the vehicle 501.

The vehicle operations data 564 may include or correspond to data indicating vehicle operational modes and/or component modes or status during operation of the vehicle 501, such as in one or more operational modes or operating scenarios/conditions. The vehicle operations data 564 may include or correspond to vehicle operations information 406 of FIG. 4.

The IVN performance data 566 may include or correspond to data indicating IVN performance during operation of the vehicle 501, such as in one or more operational modes or operating scenarios/conditions. The IVN performance data 566 may include or correspond to the IVN performance information 408 of FIG. 4.

The ECU performance data 568 may include or correspond to data indicating ECU performance during operation of the vehicle 501, such as in one or more operational modes or operating scenarios/conditions.

The association data 570 may include or correspond to data that associates vehicle operations with IVN and/or ECU performance for use in digital twin simulation operations. The association data 570 may include or correspond to the association information 442 of FIG. 4.

The local digital twin data 572 may include or correspond to data of a local instance of a digital twin of the vehicle 501. The local digital twin data 572 may include a digital representation of the functionality of the vehicle 501 and systems thereof.

The digital twin update data 574 may include or correspond to data for updating a local or network digital twin for the vehicle 501. The digital twin update may include association data, such as portions thereof, for use in digital twin simulations and/or updated digital twin modeling information or operations information, such as updated modeling parameters and/or new vehicle operational configurations to simulate.

The vehicle settings data 576 may include or correspond to data indicating a plurality of settings for the vehicle 501 overall and/or for individual components thereof. For example, the vehicle settings data 576 may include settings for normal driving, towing, winter driving, etc.

The vehicle maintenance profile data 578 may include or correspond to data used for determining what maintenance actions to perform on the vehicle 501 and at what intervals or triggers.

The vehicle operations profile data 580 may include or correspond to data indicating IVN operating parameters and/or vehicle component operating parameters for different vehicle operating scenarios, such as those indicated by the vehicle settings data 576. The vehicle operations profile data 580 may be updated or changed based on the digital twin update data 574 and/or modeling or simulation results of a local or network digital twin.

The ECU buffer data 582 may include or correspond to digital twin related data temporarily stored at ECU buffers. The digital twin related data may include ECU performance data, vehicle component status data, vehicle operations data, IVN performance data, unprocessed digital twin data, etc. Additionally, the ECU buffer data 582 may include buffer settings data for when (e.g., under what conditions) to buffer digital twin data and when to send buffered digital twin data to the digital twin components for long term storage and/or processing.

The digital twin settings data 584 may include or correspond to data indicating settings or configurations for digital twin operations or operational modes. For example, configurations or settings for when to transmit digital twin updates, push/pull configurations, relay configurations, D2D configurations, etc. The digital twin settings data 584 may include or correspond to a portion of the digital twin information 444 of FIG. 4.

The AI/ML model data 586 may include or correspond to AI or ML models for modeling vehicle systems to create the digital twin of the vehicle, to generate and/or simulate the different IVN operating parameters of the vehicle, to generate digital twin and/or vehicle updates, or a combination thereof.

The vehicle 501 further includes a sensor system 506, control systems 508, electrical systems 510, mechanical systems 512, and an IVN 518. The sensor system 506 is configured to monitor vehicle components or systems and to generate a sensor information, such as sensor data 560. For example, the sensor system 506 is configured to monitor one or more of the control systems 508, the electrical systems 510, and/or the mechanical systems 512, including components or subsystems thereof, and to generate sensor information (e.g., measurements) during operation of the vehicle 501. The sensor information may be timestamped or associated with certain vehicle operational modes and conditions, and/or may indicate or be indicative of certain vehicle operational modes and conditions. The sensor data 560 may include or correspond to the sensor information, such as be generated by or derived therefrom.

In the example of FIG. 5, the sensor system 506 includes IVN noise sensors 522, ECU sensors 524, and component sensors 526, as illustrative, non-limiting examples. The vehicle 501 may have additional types of sensors and/or other types of sensors. The IVN noise sensors 522 may be configured generate the noise frequency data 562 and noise profile data for IVN of the vehicle 501, and optionally a portion of the IVN performance data 566. The ECU sensors 524 may be configured to generate the ECU performance data 568 based on monitoring ECU performance and resources. The component sensors 526 may be configured to generate sensor information, and which may be used to determine vehicle operations data 564, IVN performance data 566, or both.

Each of the control systems 508, the electrical system 510, and the mechanical systems 512 may include components and subsystems for operating the vehicle 501. In the example of FIG. 5, the control and electrical systems 508 and 510 each include one or more subsystems, such as subsystem(s) 528 and subsystem(s) 530 respectively, and the mechanical systems 512 include a drivetrain 532 (drivetrain system) and a powertrain (powertrain system).

The IVN 518 is configured to provide communication interfaces between components and systems of the vehicle 501, such as the control systems 508, the electrical system 510, and the mechanical systems 512, and optionally one or more of wireless interface 516 (e.g., external wireless interface), safety systems 519, or media systems 520. The IVN 518 may include one or more wired networks and/or one or more wireless networks. In the example of FIG. 5, the IVN 518 includes a CAN 550, a PLC 551, and a wireless network 552. The wireless network 552 may include one or more types of wireless networks, such as Wi-Fi, Bluetooth, Bluetooth Low Energy, Zigbee, UWB, etc. The vehicle may also include other types of wired and wireless networks, such as FlexRay, LIN, etc.

The vehicle 501 also includes a digital twin system 514 configured to perform enhanced vehicle digital twin operations, such as updating the local digital twin based on real-time performance data and performing digital twin update operations between local and network digital twin instances for the vehicle 501. The digital twin update operations may include the generation of association data (e.g., real-time digital twin input data) for use by a digital twin to more accurately model or simulate vehicle performance for current operating scenarios or conditions or for new operating scenarios or conditions.

In the example of FIG. 5, the digital twin system 514 includes multiple digital twin data related modules or logic, such as a vehicle operations manager 536, a vehicle operations manager 538, and an association data manager 540, and includes a digital twin module 542. Each of the vehicle operations manager 536, the vehicle operations manager 538, and the association data manager 540 may be configured to generate corresponding digital twin related data, such as the vehicle operations data 564, the IVN performance data 566, and the association data 570. As an illustrative example, the association data manager 540 may link or association the vehicle operations data 564 and the IVN performance data 566 together based on timestamps, based on collection or generation timing (e.g., collection over a common period of time or associated with a trigger event), based on correlations between the data, etc. The association data manager 540 may optionally store the associated data together in a common database or data structure for use by the digital twin system 514.

The digital twin module 542 includes a digital twin simulator 544, a digital twin updater 546, and vehicle updater 548. The digital twin simulator 544 may be configured to perform digital twin simulations of vehicle IVN performance during different operating conditions or scenarios using the association data. To illustrate, the association data may link IVN performance as indicated in the IVN performance data 566 to certain vehicle conditions or operations as indicated in the vehicle operations data 564, and the digital twin simulator 544 may use the IVN performance during certain conditions to model or simulate (e.g., predict) IVN performance during future vehicle operations under certain conditions.

The digital twin updater 546 may be configured to make adjustments to the local vehicle digital twin and/or generate proposed adjustments to the network vehicle digital twin based on the outcome of the modeling and simulations performed by the digital twin simulator 544. To illustrate, if the digital twin simulator 544 identifies certain operating parameters with increased potential IVN performance under certain conditions (e.g., driving up a mountain with tire chains), the digital twin updater 546 may make adjustments to the local digital twin to reflect the identify improved operating parameters.

Similarly, the vehicle updater 548 may be configured to make adjustments to vehicle operations and/or generate proposed adjustments to the network for other similar vehicles based on the outcome of the modeling and simulations performed by the digital twin simulator 544. To illustrate, if the digital twin simulator 544 identifies certain operating parameters with increased potential IVN performance under certain conditions (e.g., driving up a mountain with tire chains) or adjustments to the maintenance schedule for certain operating conditions, the vehicle updater 548 may make adjustments to the vehicle operational profiles of the vehicle operational profile data 580 or to vehicle maintenance schedules or intervals of the vehicle maintenance profile data 578.

The vehicle 501 further includes the safety systems 519 and the media systems 520. The safety systems 519 may include one or more sub-systems or modules. As illustrated in the example of FIG. 5, the safety systems 519 include a collision detection/avoidance system 554 and a self-driving system 556 (e.g., autonomous or semi-autonomous driving system). The safety systems 519, such as the systems or modules thereof, may be configured to generate one or more outputs based on the modified operating parameters generated by the update digital twin. For example, the collision detection/avoidance system 554 may determine a possible collision based on object data and/or tracking data and output a notification or indication, such as an audio indication, visual indication, haptic indication, or a multi-modal indication. As another example, collision detection/avoidance system 554 or the self-driving system 556 may determine a particular action or driving maneuver (e.g., rotate the wheel 30 degrees, brake, accelerate, etc.) to avoid a collision or to operate without human intervention or to fully operate the vehicle 501 with little to no operator input.

The media systems 520 may include one or more sub-systems or modules. As illustrated in the example of FIG. 5, the media systems 520 include a radio and an infotainment system 559. The infotainment system 559 may include one or more displays (e.g., a touch screen display) which can output vehicle system information, including digital twin related information, and/or digital media. The infotainment system 559 may be configured to connect remove devices, such as UEs (e.g., cell phones) and/or control or configure the digital twin operations, such as through user input.

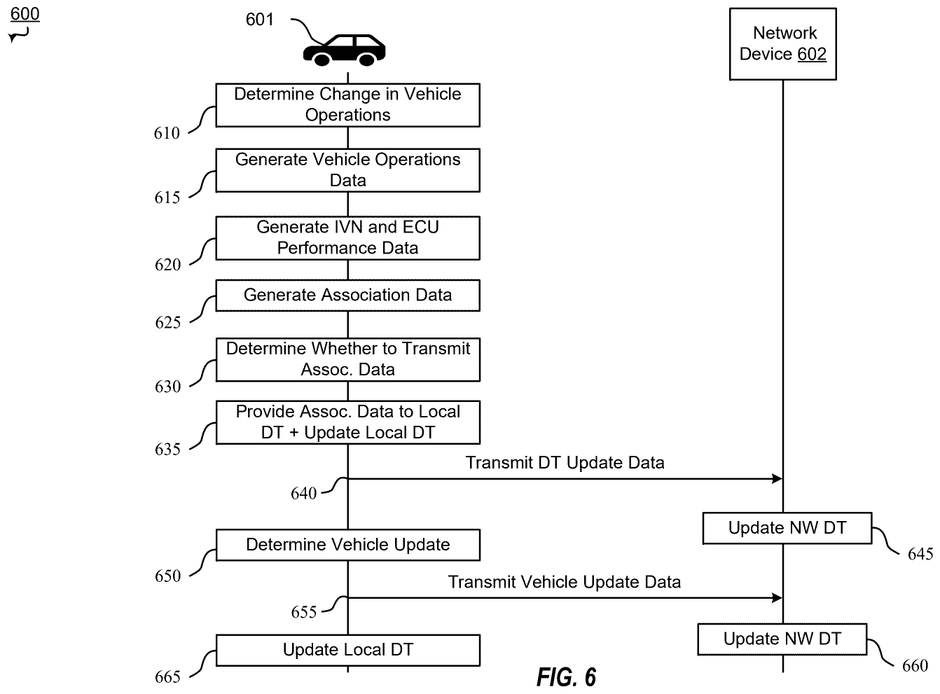

During operation, the vehicle 501 may perform enhanced vehicle digital twin operations, including association data generation operations and digital twin update operations. The vehicle 501 may generate digital twin updates based on the association data generated during or from vehicle operations. The digital twin updates may enable the generation of vehicle operations and/or maintenance updates, such as changes to improve vehicle function and/or to account for the specific components and operating conditions/scenarios for the vehicle 501. Detailed enhanced vehicle digital twin update operations for vehicles, such as the vehicle 501, are described further with reference to FIGS. 6-9.

Accordingly, the vehicle 501 may be able to perform enhanced vehicle digital twin operations by utilizing the association information and techniques described herein. The vehicle digital twin and vehicle IVN performance of the vehicle 501 will be increased due to use of additional association information generated during operation and based on the use of dual, local and network digital twins for enabling updates to local vehicle digital twins based on updates to or shared with a network digital twin.

Referring to FIG. 6, FIG. 6 is a timing diagram 600 illustrating a wireless communication system that supports enhanced vehicle digital twin operations according to one or more aspects. The example of FIG. 6 corresponds to an example of vehicle-generated digital twin update operations.

The example of FIG. 6 includes similar devices to the devices described in FIGS. 1-5, such as a vehicle 601 and a network device 602 (e.g., network entity 105, 405). The devices of FIG. 6 may include one or more of the components as described in FIGS. 2, 4, and 5. In FIG. 6, these devices may utilize antennas 252a-r, transmitter 410, receiver 412, encoder 413 and/or decoder 414, or may utilize antennas 234a-t, sensors 417, transmitter 434, receiver 436, encoder 437, and/or decoder 438 to communicate and receive digital twin related information in accordance with enhanced vehicle digital twin operations.

At 610, the vehicle 601 determines a change in vehicle operations. For example, the vehicle 601 determines a change in one or more components of the vehicle 601 and/or in the operations conditions or environment of the vehicle 601. As illustrative examples, the vehicle 601 may determine a change in gear, RPM, speed, driving mode (e.g., normal, sport, summer, winter, towing, etc.), window settings, windshield wiper settings, media system operations, phone operations, shock settings, fluid temperatures, etc. As additional illustrative examples, the vehicle 601 may determine a change in temperature, weather conditions (e.g., rain, snow, ice, etc.), road type (e.g., pavement, gravel, dirt, etc.).

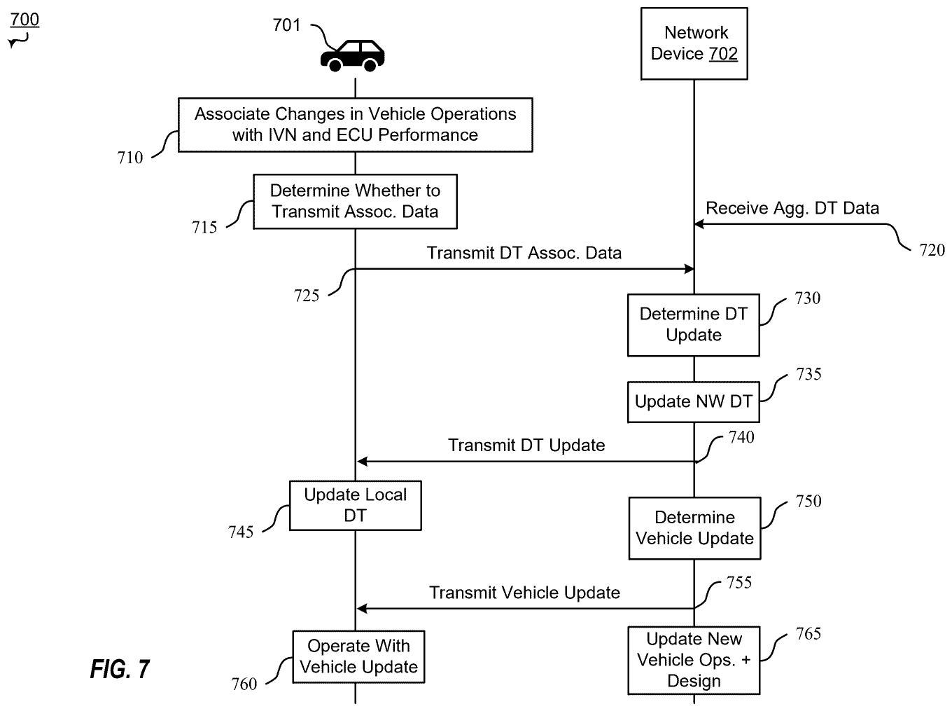

At 615, the vehicle 601 generates vehicle operations data. For example, the vehicle 601 generates and stores vehicle operations data responsive to a determined change at 610. The vehicle 601 may generate the vehicle operations data for a period of time after the determined change or may generate the vehicle operations data until a next determined change. The vehicle operations data may be stored at the ECU and/or at dedicated digital twin or ECU buffers. The storage of the vehicle operations data may depend on ECU and/or system resources, such as available bandwidth, processing power, battery, etc., as further described with reference to FIGS. 7-9.

In other implementations, the vehicle 601 generates and stores the vehicle performance data during vehicle operation and not responsive to a determined change. The vehicle 601 may store, link, or associate the generated data with the current vehicle operational state or settings.

At 620, the vehicle 601 generates IVN and ECU performance data. For example, the vehicle 601 generates and stores IVN and ECU performance data responsive to a determined change at 610. The vehicle 601 may generate the IVN and ECU performance data for a period of time after the determined change or may generate the IVN and ECU performance until a next determined change. The IVN and ECU performance may be stored at the ECU and/or at dedicated digital twin or ECU buffers. The storage of the IVN and ECU performance may depend on ECU and/or system resources, such as available bandwidth, processing power, battery, etc., as further described with reference to FIGS. 7-9.

In other implementations, the vehicle 601 generates and stores the IVN and ECU performance data during vehicle operation and/or capture of vehicle performance data and not responsive to a determined change at 610.

In some implementations, the vehicle 601 includes one or more noise frequency sensors configured to monitor noise associated with the IVN, the ECU, a PLC, or a combination thereof, and to generate noise frequency data based on the monitoring of the networks and components thereof. The vehicle 601 (e.g., a processor thereof) associate the changes in the operations of the vehicle with the changes in the IVN performance and the ECU performance to generate the association data by associating or linking the noise frequency data with vehicle operation data. The associating or linking may be performed by the local digital twin or a separate component.

At 625, the vehicle 601 generates association data. The vehicle 601 may store, link, or associate the generated the IVN and ECU performance data with the current vehicle operational state or settings and vehicle operations data.

At 630, the vehicle 601 determines whether to transmit the association data. For example, the vehicle 601 determines who or what to provide the association data to and when to provide the association data. To illustrate, the vehicle 601 determines whether to provide the association data to the local digital twin, to the network/cloud-based digital twin, or both. The determination may be based on one or more association data trigger conditions or a particular digital twin operating mode or configuration (e.g., such as association data transmission or digital twin data transmission).

Additionally, the vehicle 601 determines when to provide or send the association data. For example, the vehicle 601 may determine to provide association data to the local digital twin periodically at a designated interval, at night, while charging, while connected to a particular communication protocol, upon reaching a data storage limit, or responsive to a pull request from the network. The vehicle 601 may determine to provide the association data to the network/cloud-base digital twin based on the same conditions or on different or dedicated network transmission conditions. The network conditions may include periodically at a designated interval, at night, while charging, while connected to a particular communication protocol, upon reaching a data storage limit, or responsive to a pull request from the network.

At 635, the vehicle 601 provides the association data to a local digital twin and updates the local digital twin based on the association data. For example, the vehicle 601 sends a wired or wireless communication through the IVN or another network associated with the vehicle 601 with the association data or provides the association data across an on-chip interface.

At 640, the vehicle 601 transmits digital twin update data to the network. For example, the vehicle 601 transmits a wireless communication to a base station, which may be relayed to another device (e.g., edge or core server). The wireless communication may include or correspond to a cellular communication or another type of wireless communication. The digital twin update may be pushed to server upon one or more trigger conditions being satisfied and/or upon a pull request from the server or base station. The trigger conditions may be time based, charging condition based, communication protocol based, data storage or data transmission amount based, push request based, etc., or any combination thereof.

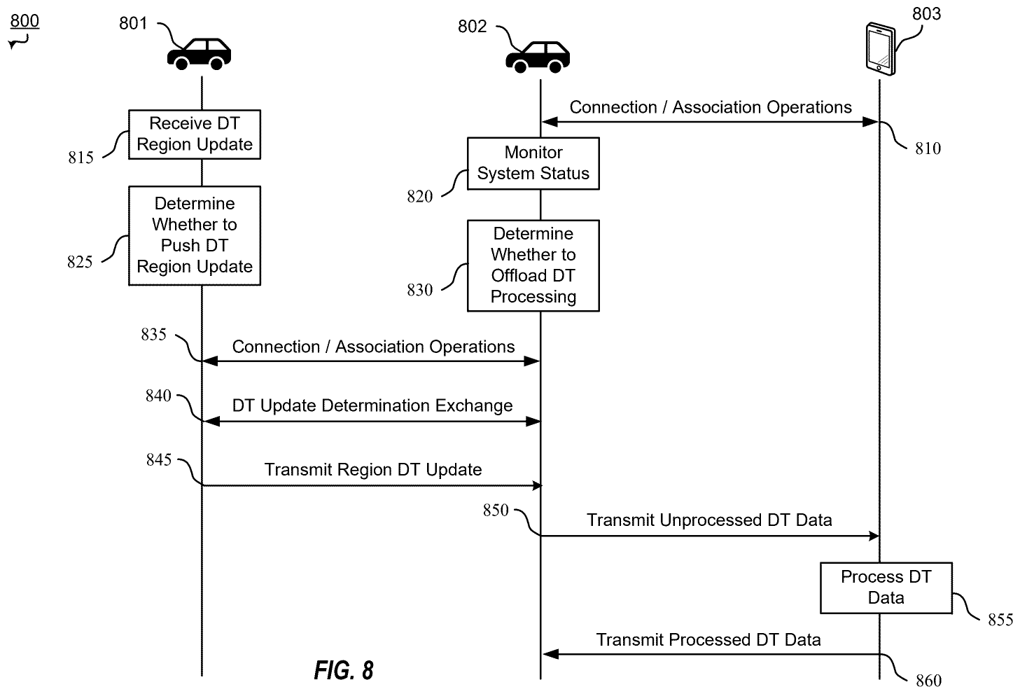

In other implementations, the wireless communication may be transmitted to another device or intermediary device and relayed to a cloud digital twin server, such as through another vehicle or a UE, as described further with reference to FIGS. 8 and 9. The digital twin update data may include a comprehensive update or a differential update only indicating the changes to the local digital twin and/or the proposed changes to the network/cloud digital twin for or associated with the vehicle 601.

The digital twin update may include or correspond to a modification to the local digital twin. The modification may include a new or updated vehicle operating profile or a new or updated vehicle maintenance profile. As an illustrative, non-limiting example, a new maintenance profile may correspond to a new maintenance profile (e.g., shorter interval or useful life for air and oil filter changes) for desert driving in a particular region and the associated high temperatures and environmental wireless interference. As another illustrative, non-limiting example, new operating profiles may include a new or modified snow operating profile with new or modified IVN network parameters for snow driving with tire chains to limit feedback/interference caused by the tire chains. To illustrate, the may be changes to a profile for changing tire type or pressure and to ensure proper coolants and fluids (e.g., antifreeze wiper fluid) for winter conditions.

In addition, the digital twin update may include updates for combinations of factors, such as terrain and weather condition combinations, such as raining on a muddy terrain. Furthermore, the update may include further details for more specific scenarios, such as for a loss of traction scenario while loaded with 4 passengers in a specific configuration (e.g., 2+2) while going downhill at an angle of 10 degrees and with a battery of 50% or lower. Additionally, or alternatively, the digital twin update may include or correspond to a proposed update for a modification of a network digital twin corresponding to the vehicle 601, such as a corresponding network instance or version of the local digital twin of vehicle 601 and/or an associated network master digital twin for multiple vehicles in a particular region or having a common type or feature of vehicle 601.

At 645, the network device 602 updates a network or cloud-based digital twin based on the digital twin update data (e.g., association data). For example, the network device 602 modifies the network or cloud-based digital twin for or associated with the vehicle 601 based on the received digital twin update data, or alternatively based on received association data. In some such implementations where the network device 602 receives association data, the network device 602 may use or otherwise process the received association data to determine its own network and/or local digital twin update based on the association data. The updating of the network or cloud-based digital twin may be additionally based on association data and/or digital twin updates from other vehicles, such as other vehicles of a similar or same type or similar or same region.

At 650, the vehicle 601 determines a vehicle update based on the updated local digital twin (e.g., association data and/or digital twin update data). The vehicle update may include or correspond to a new or updated vehicle operating profile or a new or updated vehicle maintenance profile. For example, the vehicle 601 may utilize the local digital twin, such as the updated local digital twin, to model vehicle performance given the new information (association data and/or digital twin update data). The modeling result may indicate a new or updated operating or maintenance information which may improve vehicle 601 and IVN and/or ECU performance. The digital twin may then modify or cause the vehicle 601 to modify or create new operating or maintenance modes or profiles with the update information.

Additionally, or alternatively, the network device 602 determines a vehicle update or a digital twin update based on the digital twin update data from the vehicle 601 and based on information from one or more other vehicles, as described further with reference to FIG. 7. The information may include second digital twin update data, second association data, deidentified association data or digital twin update data. The second data may include or correspond to data from other vehicles, groups of vehicles, or both. The groups of vehicles may share a common attribute, such as a same type, a same region, etc.

At 655, the vehicle 601 transmits the vehicle update to the network device 602. For example, the vehicle 601 transmits a wireless communication to a base station, which may be relayed to another device (e.g., edge or core server). The wireless communication may include or correspond to a cellular communication or another type of wireless communication. The vehicle twin update may be pushed to server upon one or more trigger conditions being satisfied and/or upon a pull request from the server or base station. The trigger conditions may be time based, charging condition based, communication protocol based, data storage or data transmission amount based, push request based, etc., or any combination thereof.

At 660, the network device 602 optionally updates the network digital twin based on the received vehicle update from the vehicle 601. For example, the network device 602 may update its own network digital twin based on the vehicle update received from the vehicle 601, such as to enable accurate modeling of the new or update vehicle mode or maintenance profile. To illustrate, the network device 602 may use the updated parameter or parameters at one or more different layers or levels in the network digital twin to model vehicle performance for future simulations. In some such implementations, the network device 602 may use a different value for a specific level or layer parameters as described with reference to FIGS. 3-5. As one illustrative, non-limiting example, the network device 602 may use a different (e.g., higher) repetition rate when driving in the rain going downhill. Additionally, or alternatively, the network device 602 may update the network digital twin based on vehicle updates from other vehicles and/or network generated vehicle updates, as described further with reference to FIGS. 7-9.

At 660, the vehicle 601 optionally updates the local digital twin based on the vehicle update. For example, the vehicle 601 may update its own local digital twin based on the vehicle update generated by vehicle 601, such as to enable accurate modeling of the new or updated vehicle mode or maintenance profile. The vehicle update may correspond to a vehicle update generated by the vehicle 601 based on modeling or simulations performed by the local digital twin using the association data.

The vehicle update may improve performance for the modeled or simulated simulations, some of which the vehicle 601 may not have experienced yet. For example, the vehicle 601 may have experienced a loss of traction while raining with a first passenger configuration and driving mode, and may have experienced a loss of traction while going downhill with a second passenger configuration and driving mode, and generated association data for those two events. The vehicle update may reflect a vehicle update for combinations of such aspects of those two experiences, such as operating parameters for loss of traction while raining with either passenger configuration and/or driving mode and for the combination of loss of traction while raining and going downhill.

As another example, the vehicle 601 may update its own local digital twin based on the vehicle update received from the network device 602, such as to enable accurate modeling of the new or updated vehicle mode or maintenance profile, in addition to or in the alternative of updating its digital twin based on its own, vehicle-generated vehicle updates. The vehicle update received may correspond to a vehicle update generated by the network based on aggregated association data and/or digital twin updates and may enable the vehicle 601 to have enhanced or optimized operations for modes and/or situations not yet experienced by the vehicle 601, but possibly experienced by other similar vehicles. Such network-generated or network-based updates are further described with reference to FIG. 7.

In some implementations, the data used by the network to generate a vehicle maintenance profile update may be different than the data used by the network to generate a vehicle operational update. To illustrate, an exemplary vehicle maintenance profile update may be determined without modeling new scenarios or conditions and based on component degradation and/or IVN or ECU performance degradation or based on indications of operations in certain or harsher environments (e.g., desert, tundra, mountain, towing, etc.).

Referring to FIG. 7, FIG. 7 is a timing diagram 700 illustrating a wireless communication system that supports enhanced vehicle digital twin operations according to one or more aspects. The example of FIG. 7 corresponds to an example of network-based digital twin update operations.

The example of FIG. 7 includes similar devices to the devices described in FIGS. 1-6, such as a vehicle 701 and a network device 702 (e.g., network entity 105, 405). The devices of FIG. 7 may include one or more of the components as described in FIGS. 2, 4, and 5. In FIG. 7, these devices may utilize antennas 252a-r, transmitter 410, receiver 412, encoder 413 and/or decoder 414, or may utilize antennas 234a-t, sensors 417, transmitter 434, receiver 436, encoder 437, and/or decoder 438 to communicate and receive digital twin related information in accordance with enhanced vehicle digital twin operations.

At 710, the vehicle 701 associates changes in vehicle operations with IVN and ECU performance. For example, the vehicle 701 may perform one or more of the actions described with reference to vehicle 601 of FIG. 6 at 610-625. To illustrate, vehicle 701 may generate vehicle operations data and IVN and ECU performance data during performance of the vehicle 701, and the vehicle 701 associates the operations data with the performance data.

At 715, the vehicle 701 determines whether to transmit the association data. For example, the vehicle 701 determines who to provide the association data to and when to provide the association data, as described with reference to vehicle 601 in FIG. 6.

At 720, the network device 702 optionally receives aggregated digital twin data from or associated with one or more second vehicles. For example, the network device 702 receives digital twin data from one or more other vehicles having a similar type and/or operating region, not shown in FIG. 7 or receives aggregated digital twin data from an edge server or base station. The aggregated digital twin data may include digital twin performance data, digital twin update data, or a combination thereof, for multiple vehicles. Additionally, or alternatively, the network device 702 receives association data for the network digital twin from the one or more other vehicles. The data may be received as aggregated data from one or more other intermediary sources, such as edge servers and/or base stations, as described with reference to FIG. 9 or relayed by intermediary sources and aggregated at the network device 702.

At 725, the vehicle 701 transmits the association data to a network digital twin associated with the network device 702. For example, the vehicle 701 transmits the association data to the network device 702 similar to and as described with reference to vehicle 601 of FIG. 6. To illustrate, the vehicle 701 transmits a wireless communication to a base station, which may be relayed to another device (e.g., edge or core server). The wireless communication may include or correspond to a cellular communication or another type of wireless communication. The association data may be pushed to the server upon one or more trigger conditions being satisfied and/or upon a pull request from the server or base station. The trigger conditions may be time based, charging condition based, communication protocol based, data storage or data transmission amount based, push request based, etc., or any combination thereof.

At 730, the network device 702 determines a digital twin update based on the association data received from the vehicle 701. For example, the network device 702 determines a network and/or local digital twin update based on the association data received from the vehicle 701, and optionally based on the aggregated digital twin and/or association data received from other vehicles. The digital twin update may be generated by processing the received association data as described with reference to FIG. 6, such as by modeling or simulating vehicle performance with the new and/or additional real-time generated digital twin input data for existing operating scenarios and/or new operating scenarios.

At 735, the network device 702 updates the network digital twin based on the determined digital twin update. For example, the network device 702 updates the network digital twin update based on the determined digital twin update, which was based on the association data received from the vehicle 701, and optionally based on the aggregated digital twin and/or association data received from other vehicles. The network device 702 may utilize the updated network digital twin to perform additional simulations and modeling for the vehicle 701 which may generate vehicle updates, local digital twin updates for one or more vehicles (including vehicle 601), or both. Utilizing the updated digital twin may be performed to validate the updated digital twin and/or create enhanced or optimized vehicle operations and/or more accurate local digital twins. Additionally, new vehicle design or modes may be generated based on utilizing the updated network digital twin.

At 740, the network device 702 optionally transmits the determined digital twin update to the vehicle 701. For example, the network device 702 transmits digital twin update data to the vehicle 701, which is based on the association data from vehicle 701 and/or aggregated association data from other vehicles, similar to and as described with reference to network device 602 of FIG. 6. To illustrate, the network device 702 transmits a wireless communication to a base station or to an edge server, which may be relayed to the vehicle directly or through another device (e.g., base station or another vehicle). The wireless communication may include or correspond to a cellular communication or another type of wireless communication. The digital twin update data may be pushed to the vehicle 701 upon one or more trigger conditions being satisfied and/or upon a pull request from the vehicle 701 or a base station. The trigger conditions may be time based, charging condition based, communication protocol based, data storage or data transmission amount based, push request based, etc., or any combination thereof.

At 745, the vehicle 701 optionally updates a local digital twin based on the digital twin update received from the network device 702. For example, the vehicle 701 may update its local digital twin based on the received digital twin update data from the network device 702 which was based in part on the association data from the vehicle 701, and similar to as described with reference to vehicle 601 of FIG. 6.

At 750, the network device 702 determines a vehicle update based on the determined digital twin update. For example, the network device 702 determines a vehicle update for the vehicle 701 based on the determined digital twin update, similar to the vehicle 601 of FIG. 6. To illustrate, the network device 702 may utilize the updated network digital twin to model vehicle performance and generate additional or modified vehicle operations or maintenance profiles. In some implementations, the network device 702 may determine the vehicle update based on the aggregated association and/or digital twin information from one or more other vehicles. For example, the network device 702 may determine the vehicle update based on multiple digital twin updates generated based on received association data from multiple vehicles or based on a single update that was determined based on association data from multiple vehicles.

At 755, the network device 702 transmits the determined vehicle update to the vehicle 701. For example, the network device 702 transmits vehicle update data to the vehicle 701 similar to and as described with reference to digital twin update data. To illustrate, the network device 702 transmits a wireless communication to a base station or to an edge server, which may be relayed to the vehicle directly or through another device (e.g., base station or another vehicle). The wireless communication may include or correspond to a cellular communication or another type of wireless communication. The vehicle update data may be pushed to the vehicle 701 upon one or more trigger conditions being satisfied and/or upon a pull request from the vehicle 701 or a base station. The trigger conditions may be the same or different from the digital twin update data trigger conditions.

At 760, the vehicle 701 operates with the vehicle update. For example, the vehicle 701 operates using the new or update vehicle operational profile. To illustrate, under certain operating conditions the vehicle 701 may operate with adjusted IVN and/or ECU parameters to improve performance and reduce noise, and similar to as described with reference to vehicle 601 of FIG. 6.

At 765, the network device 702 optionally determines new vehicle operations and/or designs based on the determined vehicle update. For example, the network device 702 may utilize the updated digital twin and/or updated vehicle operating and/or maintenance profile to design new cars, such as to design new IVN and ECU architectures or operating parameters and/or to design new maintenance profiles. As an illustrative example, the network device 702 may determine to utilize additional noise frequency sensors or digital twin ECU buffers for future vehicle designs or to route or wire a wired network in an alternative way (e.g., with more insulation or further away from a noise/interference generating component).

Referring to FIG. 8, FIG. 8 is a timing diagram 800 illustrating a wireless communication system that supports enhanced vehicle digital twin operations according to one or more aspects. The example of FIG. 8 corresponds to an example of vehicle-to-vehicle digital twin update operations and digital twin offloading operations to a UE device.

The example of FIG. 8 includes similar devices to the devices described in FIGS. 1-7, such as a first vehicle 801, a second vehicle 802, and a UE 803. The devices of FIG. 8 may include one or more of the components as described in FIGS. 2, 4, and 5. In FIG. 8, these devices may utilize antennas 252a-r, transmitter 410, receiver 412, encoder 413 and/or decoder 414, or may utilize antennas 234a-t, sensors 417, transmitter 434, receiver 436, encoder 437, and/or decoder 438 to communicate and receive digital twin related information in accordance with enhanced vehicle digital twin operations.

At 810, a second vehicle 802 and a UE 803 perform wireless connection and/or association operations. For example, the second vehicle 802 and the UE 803 may exchange association or connection message by direct communications (e.g., sidelink or V2X communications) or by a local wireless communication network, such as Wi-Fi or Bluetooth.

At 815, a first vehicle 801 receives a regional digital twin update. For example, the first vehicle 801 receives regional digital twin update data from an edge server or base station. The regional digital twin update data may include a correspond to a digital twin update, as described herein, for a particular region or locality. The regional digital twin update data may be applicable for a specific area, such as for the local weather and/or road conditions, the local wireless interference conditions, or both. The regional digital twin update data may include an indicator or identifier for the particular region of interest, for the region of use, or both. The region of interest may identify a region where vehicles should be updated with regional update and the region of use may identify where the regional update should be used. To illustrate, the first vehicle 801 receives a wireless communication from a base station or to an edge server with as vehicle update data. The vehicle update data may be pushed to the vehicle 801 upon one or more trigger conditions being satisfied and/or upon a pull request from the vehicle 801 or a base station. The trigger conditions may be the same as or different from the digital twin update data trigger conditions described with reference to FIGS. 6 and 7.

At 820, the second vehicle 802 monitors a system status. For example, the second vehicle 802 monitors one or more system resources of the vehicle's components, such as the ECU, the IVN, the PLC, wireless networks, etc. The system resources may include one or more of ECU/CPU usage, memory usage, bandwidth usage, packet error rate, battery level, noise level, etc.

At 825, the first vehicle 801 determines whether to push the received regional digital twin update to one or more other vehicles. For example, the first vehicle 801 determines whether to push the received regional digital twin update to one or more other vehicles based on an indicator received with the regional digital twin update or based on a prior configuration message or user setting.

At 830, the second vehicle 802 determines whether to offload digital twin processing. For example, the second vehicle 802 monitors one or more system resources and compares the determined system resource or resource values to one or more corresponding conditions or thresholds. The system resources may include one or more of CPU usage, memory usage, bandwidth usage, packet error rate, battery level, noise level, etc. As an example illustration, the second vehicle 802 may determine to offload processing to the UE 803 when the second vehicle 802 is low on power, is low on bandwidth, has high memory and/or CPU usage, has high packet error rates, or any combination thereof.

Additionally, the second vehicle 802 may determines whether to offload digital twin processing based on a particular operational mode or setting. For example, a user setting or configuration or preference may be set to indicate to offload for UE processing or a vehicle may offload for UE processing responsive to a UE capability or availability message. As another example, the second vehicle 802 may determine to offload digital twin processing during certain (e.g., high risk or high performance) driving modes, such as mountain and/or snow driving modes or towing driving mode, or the second vehicle 802 may adjust the thresholds (e.g., increase or decrease) for offloading digital twin processing certain driving modes, such as to decrease the thresholds for high risk or high performance driving modes.

At 835, the first vehicle 801 and the second vehicle 802 perform wireless connection and/or association operations. For example, the first vehicle 801 and the second vehicle 802 may exchange association or connection message by direct communications (e.g., sidelink or V2X communications) or may establish a communication link via a base station or other intermediary device to facilitate communications between the vehicles.

At 840, the first vehicle 801 and the second vehicle 802 perform a digital twin update determination. For example, the first vehicle 801 and the second vehicle 802 may exchange direct communications (e.g., sidelink or V2X communications) or communications via a base station or other intermediary to determine which digital twin version or updates vehicles have received. To illustrate, each vehicle may indicate which digital twin updates they have received by including a digital twin update identifier or digital twin update identification information. A single update (e.g., a most recent update) or multiple updates may be identified, such as a last X amount of updates, in such messages. In some implementations, the vehicles may indicate a particular digital twin version ID in one of the messages.

At 845, a first vehicle 801 transmits the received regional digital twin update to the second vehicle 802. For example, the first vehicle 801 relays the received regional digital twin update to the second vehicle 802 via a sidelink or V2X communication based on a determination to relay the update. The determination to relay the update may be determined based on the first vehicle 801 determining that the second vehicle 802 does not have the update and optionally is in the region of interest/applicability for the update and/or has a corresponding type associated with the update. As another example, the first vehicle 801 transmits a digital twin update to the second vehicle 802 via a base station. In some implementations, the first vehicle 801 may receive one of a comprehensive update or a differential update from the regional server or base station, and may transmit the other of the comprehensive update or the differential update to the second vehicle 802.

At 850, the second vehicle 802 transmits unprocessed digital twin data to the UE 803. For example, the second vehicle 802 transmits vehicle operations and/or IVN or ECU performance data to the UE 803 via a local wireless connection, such as Wi-Fi or Bluetooth. As another example, the second vehicle 802 transmits association data or update data to the UE 803 via the local wireless connection.

At 855, the UE 803 processes the unprocessed digital twin data from the second vehicle 802. For example, the UE 803 associates received vehicle operations data and IVN or ECU performance data. As another example, the UE 803 stores or associates vehicle performance data with a particular operational mode to generate vehicle operations data. As yet another example, the UE 803 performs digital twin modeling or generates digital twin or association data update messages for the second vehicle 802.

At 860, the second vehicle 802 receives processed digital twin data from the UE 803. For example, the second vehicle 802 receives association data from the UE 803 via a local wireless connection, such as Wi-Fi or Bluetooth. As another example, the second vehicle 802 receives digital twin simulation data from the UE 803 via the local wireless connection.

Referring to FIG. 9, FIG. 9 is a timing diagram 900 illustrating a wireless communication system that supports enhanced vehicle digital twin operations according to one or more aspects. The example of FIG. 9 corresponds to an example of distributed digital twin operations and localized or regional digital twin update operations.

The example of FIG. 9 includes similar devices to the devices described in FIGS. 1-8, such as one or more vehicles 901, a first network device 902 (e.g., a regional or edge server or base station), and a second network device 903 (e.g., a core network server or separate/cloud digital server). The devices of FIG. 9 may include one or more of the components as described in FIGS. 2, 4, and 5. In FIG. 9, these devices may utilize antennas 252a-r, transmitter 410, receiver 412, encoder 413 and/or decoder 414, or may utilize antennas 234a-t, sensors 417, transmitter 434, receiver 436, encoder 437, and/or decoder 438 to communicate and receive digital twin related information in accordance with enhanced vehicle digital twin operations.

At 910, a second network device 903 optionally transmits a pull request to a first network device 902. For example, the second network device 903 transmits a pull request to the first network device 902 for digital twin related data associated with the one or more vehicles 901. The digital twin related data may include or correspond to association data, digital twin update data, aggregated/deidentified association data, or aggregated/deidentified digital twin update data.

At 915, the first network device 902 optionally transmits a pull request to one or more vehicles 901. For example, the first network device 902 transmits one or more second pull requests to the one or more vehicles 901 for digital twin related data associated with the one or more vehicles 901 based on receiving the pull request from the second network device 903. As another example, the first network device 902 transmits one or more pull requests to the one or more vehicles 901 for digital twin related data associated with the one or more vehicles 901 independent of receiving a pull request from the second network device 903 and based on one or more conditions being satisfied, such as one or more of the digital transmission push conditions described with reference to FIGS. 6-8.

From 920 to 925, the one or more vehicles 901 transmit association data, digital twin data, or both, to the first network device 902. For example, the one or more vehicles 901 wirelessly transmit the association data, the digital twin data, or both, to the first network device 902 responsive to the second pull requests from the first network device 902. As another example, the one or more vehicles 901 wirelessly transmit the association data, digital twin data, or both to the first network device 902 based on satisfying one or more push or digital twin data transmission conditions.

At 930, the first network device 902 anonymizes or deidentifies the data received from the one or more vehicles 901. For example, the first network device 902 anonymizes or deidentifies the data received from the one or more vehicles 901 and aggregates the data for particular regions, types of vehicles, groups of vehicles, etc.

At 935, the first network device 902 transmits the deidentified data to the second network device 903. For example, the first network device 902 transmits the deidentified data to the second network device 903 via a wireless or wired communication responsive to the pull request at 910 or based on one or more push conditions or aggregate data transmission conditions.

At 940, the first network device 902 optionally determines a regional digital twin update, a regional vehicle update, or both. For example, the first network device 902 determines a regional digital twin update, a regional vehicle update, or both based on the received association data and/or received digital twin data from the one or more vehicles 901, similar to as described with reference to FIGS. 4-8. In some implementations, the first network device 902 determines the update or updates based on the deidentified data.

At 945, the second network device 903 processes the received deidentified data received from the first network device 902. For example, the second network device 903 uses received deidentified association data to update the network digital twin or twins. As another example, the second network device 903 uses received deidentified digital twin update data to update the network digital twin or twins.

At 950, the first network device 902 transmits the regional digital twin update, the regional vehicle update, or both. For example, the first network device 902 wirelessly transmits the regional digital twin update, the regional vehicle update, or both to vehicles within or associated with a region corresponding to and/or identified in the regional update. To illustrate, the first network device 902 transmits regional digital twin update data, regional vehicle update data, or both in one or more wireless communications to the one or more vehicles 901. When sending the regional digital twin update data and the regional vehicle update data, the data may be sent in separate messages or the same message. The wireless communication may include or correspond to a downlink transmission or a sidelink transmission, as illustrative, non-limiting examples.

At 955, the second network device 903 determines a digital twin update, a vehicle update, or both. For example, the second network device 903 determines a digital twin update, a vehicle update, or both based on the received deidentified association data and/or digital twin data from the first network device 902 and optionally based on second deidentified association data and/or digital twin data from another network device (not shown in FIG. 9, e.g., a edge server corresponding to another region), association or digital twin update from one or more second vehicles (not shown in FIG. 9, e.g., vehicles corresponding to the other region), similar to as described with reference to FIGS. 4-8.

At 960, the second network device 903 transmits the digital twin update, the vehicle update, or both. For example, the second network device 903 transmits the digital twin update, the vehicle update, or both to all vehicles of a particular type. To illustrate, the second network device 903 transmits digital twin update data, vehicle update data, or both in one or more wireless communications to the one or more vehicles 901 and to the one or more second vehicles. When sending both the digital twin update data and the vehicle update data, the data may be sent in separate messages or the same message. The wireless communication may include or correspond to a downlink transmission or a sidelink transmission, as illustrative, non-limiting examples. In some such implementations, the second network device 903 transmits the data to one or more edge servers and/or base stations, and the edge servers and/or base stations relay the transmissions to the vehicles.

Although not shown in the example of FIG. 9, in other implementations a vehicle which receives the update data from the second network device 903 (e.g., directly or indirectly) may relay the update data to other vehicles as described with reference to FIG. 8. Additionally, a vehicle which receives the update data from the second network device 903 (e.g., directly or indirectly) may use the update data as described with reference to FIGS. 4-8.

As described above, the vehicle may include one or more dedicated digital twin ECU memory buffers coupled to the ECU. The one or more digital twin ECU memory buffers may be configured to store digital twin related data, such as network and traffic condition data of the ECU, the IVN, or both, generated by the ECU during operation of the vehicle and for association with the changes in the operations of the vehicle.

In some implementations, the vehicle (e.g., a processor thereof) stores the generated network and traffic condition data at the one or more digital twin ECU memory buffers temporarily and only when one or more buffer storage conditions are satisfied. The stored or buffered data may then be transferred to other memory or storage when the buffer storage conditions are not satisfied and/or when data storage conditions are satisfied.

For example, the vehicle may transmit the stored network and traffic condition data from the one or more digital twin ECU memory buffers to a local digital twin for the vehicle when one or more buffer transfer conditions are satisfied, and may transmit the generated network and traffic condition data to the local digital twin for the vehicle and independent of the one or more digital twin ECU memory buffers when the one or more buffer storage conditions are not satisfied or when one or more data storage conditions are satisfied (e.g., when system resources are above a threshold).

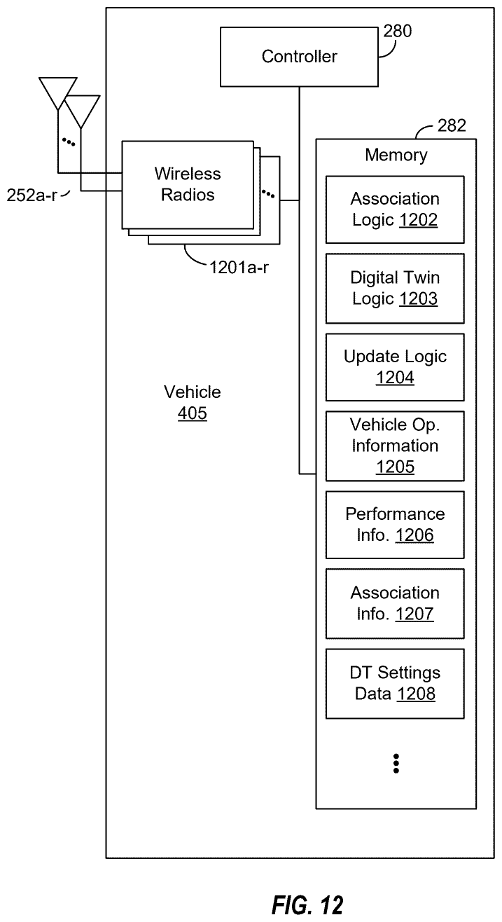

FIG. 10 is a flow diagram 1000 illustrating example blocks executed by a wireless communication device (e.g., a UE or vehicle) configured according to an aspect of the present disclosure. The example blocks will also be described with respect to vehicle 401 as illustrated in FIG. 12. FIG. 12 is a block diagram illustrating vehicle 401 configured according to one aspect of the present disclosure. Vehicle 401 includes the structure, hardware, and components as illustrated for UE 115 of FIG. 2 and/or vehicle 401 of FIG. 4. For example, vehicle 401 includes controller/processor 280, which operates to execute logic or computer instructions stored in memory 282, as well as controlling the components of vehicle 401 that provide the features and functionality of vehicle 401. Vehicle 401, under control of controller/processor 280, transmits and receives signals via wireless radios 1201a-r and antennas 252a-r. Wireless radios 1201a-r include various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 12, memory 282 stores association logic 1202, digital twin logic 1203, update logic 1204 (e.g., digital twin and/or vehicle update logic), vehicle operations information 1205, performance information 1206 (e.g., vehicle IVN and/or ECU performance), association information 1207, and digital twin settings data 1208. The data (1202-1208) stored in the memory 282 may include or correspond to the data (406, 408, 442, and/or 444-446) stored in the memory 404 of FIG. 4.

At block 1002, a device, such as a UE or a vehicle, associates changes in operations of a vehicle with changes in in-vehicle network (IVN) performance and electronic control unit (ECU) performance to generate association data. The vehicle may include or correspond to the vehicle 401 of FIG. 4, the vehicle 501 of FIG. 5, the vehicle 601 of FIG. 6, the vehicle 701 of FIG. 7, the vehicle 801 or the vehicle 802 of FIG. 8, or the vehicles 901 of FIG. 9. The association data may include or correspond to the association information 442 of FIG. 4, the association data 570 of FIG. 5, or the association data of any of FIGS. 6-9. The changes in the operations of the vehicle may include or correspond to the vehicle operations information 406 of FIG. 4, vehicle operations data 564 of FIG. 5, or vehicle operations data of any of FIGS. 6-9, and the changes in IVN performance and ECU performance of the vehicle may include or correspond to the IVN performance information 408 of FIG. 4, the IVN performance data 566 and/or the ECU performance data 568 of FIG. 5, or the IVN and ECU performance data of any of FIGS. 6-9. In some aspects, the device may include or correspond to one or more components of the vehicle for wireless communication, such as an apparatus for wireless communication at the vehicle.

For example, the vehicle 401 may generate or receive sensor information from the sensors 417, as described with reference to FIG. 4, and may generate vehicle operations information 406 based on the sensor information and/or based on received information (e.g., status information) from components and systems of the vehicle 401, such as systems of vehicle 501 in FIG. 5. The vehicle 401 may associate, such as link, tag, store together, etc., the vehicle operations information 406 with ECU and/or IVN performance information 408 to generate the association information 442. To illustrate, the association information 442 may include or correspond to a database or data structure with the vehicle operations information 406 and with the ECU and/or IVN performance information 408 or may include or correspond to tagging or linking information which correlates the vehicle operations information 406 with ECU and/or IVN performance information 408.

At block 1004, the device provides the association data to a digital twin associated with the vehicle, the association data configured to cause the digital twin to model performance of the vehicle and generate modified operating parameters. The digital twin associated with the vehicle may include or correspond to a local or in-vehicle digital twin simulating the vehicle 401, such as the digital twin information 444 of FIG. 4, the local digital twin data 572 or the digital twin settings data 584 of FIG. 5, or any of the local digital twins of FIGS. 6-9. Modelling performance of the vehicle may include or correspond to using the local, in-vehicle digital twin to model performance of the vehicle with different operating parameters. The modified operating parameters may include or correspond to operating parameters for the vehicle ECU and/or IVN which are different from the set or stored operating parameters to evaluate different parameter values for improved performance. For example, the vehicle may determine to modify a value of one or more parameters for the IVN and evaluate the impact of the modified operating parameter(s) on the operations of the vehicle 401, as described with reference to FIGS. 4-9. In some implementations, the vehicle 401 may use an AI or ML model to determine the modified operating parameters to evaluate in modelling performance of the vehicle.

The device (e.g., UE or vehicle) may execute additional blocks (or the device may be configured further to perform additional operations) in other implementations. For example, the device (e.g., the vehicle 401 or the UE 115) may perform one or more operations described above, such as described with reference to FIGS. 4-9. As another example, the device (e.g., the vehicle 401 or the UE 115) may perform one or more aspects as presented below.

Accordingly, wireless communication devices may perform enhanced vehicle digital twin operations for wireless communication devices. By performing enhanced vehicle digital twin operations, such as using real-time association data to update a local or network digital twin, digital twin management over the life of the vehicle can be performed with less resources and more effectively. The more accurate digital twin may enable improved IVN performance and/or reduce IVN degradation over time, and improved network performance overall.

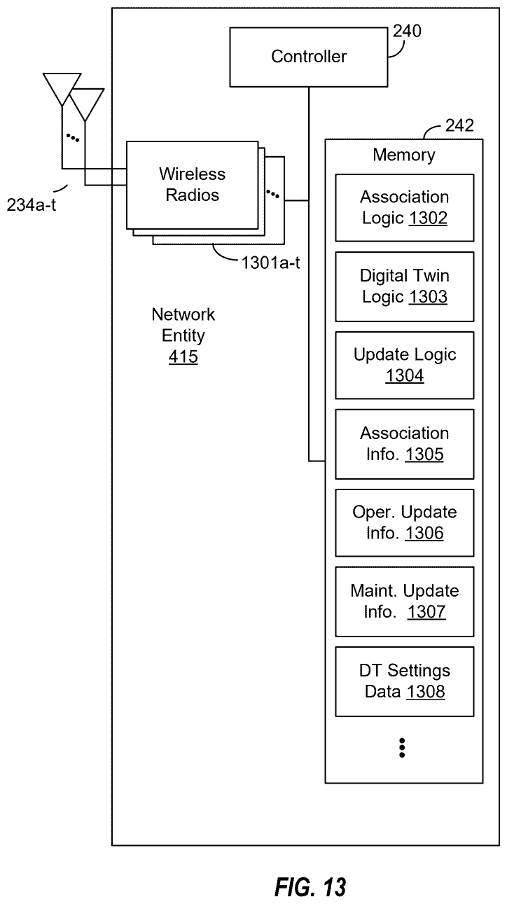

FIG. 11 is a flow diagram 1100 illustrating example blocks executed wireless communication device (e.g., a UE or network node, such as a base station) configured according to an aspect of the present disclosure. The example blocks will also be described with respect to network entity 405 as illustrated in FIG. 13. FIG. 13 is a block diagram illustrating network entity 405 configured according to one aspect of the present disclosure. Network entity 405 includes the structure, hardware, and components as illustrated for network node 105 (e.g., a base station), UE 115, vehicle 401, and/or network entity 405 of FIGS. 2 and/or 4. For example, network entity 405 includes controller/processor 240, which operates to execute logic or computer instructions stored in memory 242, as well as controlling the components of network entity 405 that provide the features and functionality of network entity 405. Network entity 405, under control of controller/processor 240, transmits and receives signals via wireless radios 1301a-t and antennas 234a-t. Wireless radios 1301a-t include various components and hardware, as illustrated in FIG. 2 for network node 105, including modulator/demodulators 232a-t, MIMO detector 236, receive processor 238, transmit processor 220, and TX MIMO processor 230. As illustrated in the example of FIG. 13, memory 242 stores association logic 1302, digital twin logic 1303, update logic 1304 (e.g., digital twin and/or vehicle update logic), association information 1305, operational update information 1306, maintenance update information 1307, and digital twin settings data 1308. The data (1302-1308) stored in the memory 242 may include or correspond to the data (406, 408, 442, and/or 444-446) stored in the memory 432 of FIG. 4.

At block 1102, a wireless communication device, such as a base station or server (e.g., network node 105 or any of the regional/edge or cloud servers of FIGS. 5-9), receives association data associated with a vehicle type generated by an in-vehicle digital twin. The association data may include or correspond to the association information 442 of FIG. 4, the association data 570 of FIG. 5, or the association data of any of FIGS. 6-9. The vehicle type may include or correspond to a make, model, a particular trim, or a class of vehicle and may be indicated by vehicle operations data and/or vehicle profile data. The in-vehicle digital twin may include or correspond to a local, vehicle-based digital twin which simulates performance of a vehicle of any of FIGS. 4-9. For example, the network entity 405 may receive the association data transmission 452 including the association information 442 of FIG. 4. To illustrate, the network entity 405 receives an uplink transmission via wireless radios 1301a-t and antennas 234a-t from the vehicle 401 or may receive a communication from the vehicle 401 which is relayed by another device or server.

At block 1104, the wireless communication device evaluates in-vehicle network (IVN) performance and electronic control unit (ECU) performance with adjusted operating parameters using a cloud digital twin associated with the vehicle type and based on the association data. The changes in IVN performance and ECU performance of the vehicle may include or correspond to the IVN performance information 408 of FIG. 4, the IVN performance data 566 and/or the ECU performance data 568 of FIG. 5, or the IVN and ECU performance data of any of FIGS. 6-9. The adjusted operating parameters may include or correspond to the adjusted operational parameters for the IVN and/or ECU of the vehicle, as described with reference to FIG. 4 or FIG. 5. The cloud digital twin may include or correspond to a master or out-of-vehicle based digital twin which simulates performance of the vehicle itself or a group of vehicles associated with a particular vehicle type. For example, the network entity 405 may determine adjusted operating parameters based on the association information 442 from the vehicle 401, and may use the digital twin information 444 to evaluate IVN performance and ECU performance using the adjusted operating parameters.

The wireless communication device may evaluate the IVN performance and ECU performance using the adjusted operating parameters which are based on the association data and/or digital twin updates from multiple vehicles. The multiple vehicles may have a similar type or operating location. The adjusted operating parameters may be selected from a set of defined operating parameters or rules for selecting different operating parameters or based on operating parameters output from an AI or ML model.

At block 1106, the wireless communication device determines one or more modified operating parameters for the vehicle type based on the evaluation of the IVN performance and the ECU performance with the adjusted operating parameters. The one or more modified operating parameters may include or correspond to the one or more modified operating parameters described with reference to FIG. 4 or FIG. 5, such as selected operating parameters for future use from the adjusted operating parameters. The one or more modified operating parameter may offer improved vehicle performance over the original operating parameters. For example, the network entity 405 determines one or more modified operating parameters for the vehicle type based on the evaluation of the IVN performance and the ECU performance with the adjusted operating parameters using the digital twin information 444 (e.g., a network-based digital twin). The network-based digital twin may be a master or regional digital twin for multiple vehicles or a network-based copy of the vehicle twin for the specific vehicle. In some implementations, the network entity 405 may include multiple types of digital twins and may develop the modified operating parameters using two or more digital twins, or may develop first modified operating parameters and second modified operating parameters using one or more of the digital twins. The wireless communication device may determine one or more modified operating parameters for the vehicle type based on selecting an adjusted parameter which the digital twin modelling indicates offers improved or optimal performance.

At block 1108, the wireless communication device provides an update to one or more vehicles associated with the vehicle type based on the one or more determined modified operating parameters. The update may include or correspond to one or more of the updates described with reference to FIGS. 4-9, such as the vehicle update of the vehicle update transmission 456 of FIG. 4, vehicle maintenance profile data 578 and/or vehicle operational profile data 580 of FIG. 5, the vehicle update or digital twin update of FIG. 6, the vehicle update or digital twin update of FIG. 7, the regional digital twin updates of FIG. 8, or the regional vehicle updates or regional digital twin updates of FIG. 9. For example, the network entity 405 may transmit the digital twin update transmission 454, including the digital twin information 444 of FIG. 4, to the vehicle 401, as described with reference to FIG. 4. To illustrate, the network entity 405 transmits a downlink transmission via wireless radios 1301a-t and antennas 234a-t to the vehicle 401 or may transmit a communication to another device (e.g., base station or server) which is the relayed by the other device to the vehicle 401 by wireless communication. Other digital twin related update examples are described further with reference to FIGS. 5-9.

As another example, the network entity 405 may transmit the vehicle update transmission 456 including the region information 445 of FIG. 4 or vehicle update information (e.g., operational and/or maintenance update information) to the vehicle 401, as described with reference to FIG. 4. To illustrate, the network entity 405 transmits a downlink transmission via wireless radios 1301a-t and antennas 234a-t to the vehicle 401 or may transmit a communication to another device (e.g., base station or server) which is the relayed by the other device to the vehicle 401 by wireless communication. Other vehicle related update examples are described further with reference to FIGS. 5-9.

The wireless communication device (e.g., such as a network entity 105, 405) may execute additional blocks (or the wireless communication device may be configured further to perform additional operations) in other implementations. For example, the wireless communication device (e.g., a base station or a server) may perform one or more operations as described with reference to FIGS. 4-11. As another example, the wireless communication device (e.g., the base station or the server) may perform one or more aspects as presented below.

Accordingly, wireless communication devices may perform enhanced vehicle digital twin operations for wireless communication devices. By performing enhanced vehicle digital twin operations, such as using real-time association data to update a network digital twin, digital twin management over the life of the vehicle can be performed with less resources and more effectively across multiple vehicles. The more accurate digital twin may enable improved IVN performance and/or reduce IVN degradation over time, and improved network performance overall.

In a first aspect, an apparatus for wireless communication at a vehicle comprises: one or more sensors; at least one processor; and a memory coupled to the at least one processor. The at least one processor is configured to cause the apparatus to: associate changes in operations of a vehicle with changes in in-vehicle network (IVN) performance and electronic control unit (ECU) performance to generate association data; and provide the association data to a digital twin associated with the vehicle, the association data configured to cause the digital twin to model performance of the vehicle and generate modified operating parameters.

In a second aspect, alone or in combination with the first aspect, the association data includes or corresponds to a data structure or database including vehicle operations data linked with corresponding IVN and ECU performance data or to linking information which associates the vehicle operations data with the corresponding IVN and ECU performance data.

In a third aspect, alone or in combination with one or more of the first aspect or the second aspect, the least one processor configured to cause the apparatus to associate the changes in the operations of the vehicle with changes in the IVN performance and the ECU performance to generate the association data includes to: generate vehicle operations data based on at least one detected change in the operations of the vehicle over a time period; generate IVN and ECN performance change data based on detected changes in the IVN performance and the ECU performance to over the time period; and generate the association data by linking the vehicle operations data with the IVN and ECN performance change data. In some aspects, the least one processor configured to cause the apparatus to associate the changes in the operations of the vehicle with changes in the IVN performance and the ECU performance to generate the association data further includes to: detect a change in the operations of the vehicle, such as based on one or more changes in vehicle operating parameters.

In a fourth aspect, alone or in combination with one or more of the above aspects, the at least one processor configured to cause the apparatus to provide the association data includes to: send the association data to a local digital twin of the vehicle; and generate, using the local digital twin and the association data, the modified operating parameters for the vehicle, wherein the vehicle is operated using the modified operating parameters. In some aspects, the least one processor is configured to cause the vehicle to operate using the modified operating parameters or the least one processor is configured to cause the apparatus to cause the vehicle to operate using the modified operating parameters.

In a fifth aspect, alone or in combination with one or more of the above aspects, the modified operating parameters include application level parameters, IP level parameters, MAC level parameters, Physical layer parameters, or a combination thereof.

In a sixth aspect, alone or in combination with one or more of the above aspects, the at least one processor configured to cause the apparatus to provide the association data includes to: update the local digital twin of the vehicle based on the modified operating parameters; generate a digital twin update for a network digital twin associated with the vehicle based on the updated local digital twin of the vehicle; and transmit the digital twin update to a network device including the network digital twin associated with the vehicle.

In a seventh aspect, alone or in combination with one or more of the above aspects, the at least one processor is configured to cause the apparatus to provide the association data includes to: transmit the association data to a network device including a network digital twin associated with the vehicle; and receive a vehicle update for the vehicle, a digital twin update for a local digital twin associated with the vehicle, or both, based on transmission of the association data, wherein the vehicle is operated using the modified operating parameters, and wherein the modified operating parameters are indicated by the vehicle update or generated by the local digital twin based on the digital twin update. In some aspects, the least one processor is configured to cause the vehicle to operate using the modified operating parameters or the least one processor is configured to cause the apparatus to cause the vehicle to operate using the modified operating parameters.

In an eighth aspect, alone or in combination with one or more of the above aspects, the vehicle update includes or corresponds to a new or updated vehicle operating profile or a new or updated vehicle maintenance profile.

In a ninth aspect, alone or in combination with one or more of the above aspects, the digital twin update includes or corresponds to a modification to the local digital twin for a new or updated vehicle operating profile or a new or updated vehicle maintenance profile.

In a tenth aspect, alone or in combination with one or more of the above aspects, the vehicle further comprises at least one sensor (e.g., one or more noise frequency sensors) configured to monitor noise associated with the IVN, the ECU, a PLC, or a combination thereof, and to generate noise frequency data, and the at least one processor configured to cause the apparatus to associate the changes in the operations of the vehicle with the changes in the IVN performance and the ECU performance to the generate association data includes to: associate the noise frequency data with vehicle operation data using a local digital twin for the vehicle to generate a portion of the association data.

In an eleventh aspect, alone or in combination with one or more of the above aspects, the vehicle further comprises one or more digital twin ECU memory buffers coupled to the ECU, the one or more digital twin ECU memory buffers configured to store network and traffic condition data of the ECU, the IVN, or both, generated by the ECU during operation of the vehicle and for association with the changes in the operations of the vehicle, and the at least one processor is further configured to cause the apparatus to: store the generated network and traffic condition data at the one or more digital twin ECU memory buffers temporarily when one or more buffer storage conditions are satisfied; transmit the stored network and traffic condition data from the one or more digital twin ECU memory buffers to a local digital twin for the vehicle when one or more buffer transfer conditions are satisfied; and transmit the generated network and traffic condition data to the local digital twin for the vehicle (e.g., directly to an association manager thereof) and independent of the one or more digital twin ECU memory buffers when the one or more buffer storage conditions are not satisfied.

In a twelfth aspect, alone or in combination with one or more of the above aspects, the at least one processor is further configured to cause the apparatus to: receive a vehicle connection request from a user equipment (UE) associated with the vehicle; determine whether to offload local digital twin processing to the UE based on a digital twin processing offload condition and on one or more digital twin operating metrics or one or more vehicle operating parameters; transmit digital twin processing data to the UE based on determining that the digital twin processing offload condition has been satisfied by the one or more digital twin operating metrics, the one or more vehicle operating parameters, or both; and receive processed digital twin data from the UE and corresponding to the digital twin processing data.

In a thirteenth aspect, alone or in combination with one or more of the above aspects, the at least one processor is further configured to cause the apparatus to: determine whether to reduce or suspend local digital twin processing based on a digital twin processing modification condition and on one or more digital twin operating metrics or one or more vehicle operating parameters; reduce or suspend the local digital twin processing based on determining that the digital twin processing modification condition has been satisfied by the one or more digital twin operating metrics, the one or more vehicle operating parameters, or both; and increase or resume the local digital twin processing based on determining that the digital twin processing modification condition is no longer satisfied by the one or more digital twin operating metrics, the one or more vehicle operating parameters, or both.

In a fourteenth aspect, alone or in combination with one or more of the above aspects, the at least one processor is further configured to cause the apparatus to: receive a new or modified driving or maintenance profile associated with a vehicle type of the vehicle from a network device including a network digital twin for the vehicle, the new or modified driving or maintenance profile determined based on the association data and on aggregated digital twin data.

In a fifteenth aspect, alone or in combination with one or more of the above aspects, the at least one processor is further configured to cause the apparatus to: receive a vehicle or local digital twin update for a vehicle type associated with the vehicle and from a network device including a network digital twin associated with the vehicle; and transmit the vehicle or digital twin update to one or more other vehicles having the vehicle type using a local wireless network or D2D communications.

In a sixteenth aspect, alone or in combination with one or more of the above aspects, the at least one processor is further configured to cause the apparatus to: the at least one processor is configured to cause the apparatus to: receive a vehicle or local digital twin update from a second vehicle having a same vehicle type as the vehicle using a local wireless network or D2D communications.

In a seventeenth aspect, alone or in combination with one or more of the above aspects, the at least one processor is further configured to cause the apparatus to: receive second association data or a vehicle or digital twin update from a second vehicle having a same vehicle type as the vehicle using a local wireless network or D2D communications; and relay the second association data or a vehicle or digital twin update to the network.

In an eighteenth aspect, alone or in combination with one or more of the above aspects, the at least one processor is further configured to cause the apparatus to: receive or transmit the association data, a vehicle update, a digital twin update, or a combination thereof, periodically at a designated interval, at night, while charging, while connected to a particular communication protocol, upon reaching a data storage limit, or responsive to a pull request from the network.

In a nineteenth aspect, alone or in combination with one or more of the above aspects, the vehicle update or the digital twin update is a comprehensive update or is a differential update indicating a change from a previously configured value.

In a twentieth aspect, a device for wireless communication comprises at least one processor and a memory coupled to the at least one processor. The at least one processor is configured to cause the device to: receive association data associated with a vehicle type generated by an in-vehicle digital twin; evaluate in-vehicle network (IVN) performance and electronic control unit (ECU) performance with adjusted operating parameters using a cloud digital twin associated with the vehicle type and based on the association data; determine one or more modified operating parameters for the vehicle based on the evaluation of the IVN performance and the ECU performance with the adjusted operating parameters; and provide an update to one or more vehicles associated with the vehicle type based on the one or more determined modified operating parameters.

In a twenty-first aspect, alone or in combination with the twentieth aspect, the at least one processor is further configured to cause the device to: receive multiple sets of second association data associated with the vehicle type; receive multiple sets of third association data associated with a second vehicle type; receive local digital twin performance data from one or more vehicles associated with the vehicle type, one or more second vehicles associated with the second vehicle type, or both; generate a modified IVN architecture based on an IVN architecture of the vehicle type, the second vehicle type, or both, using one or more of the association data, the second association data, the third association data, or the local digital twin performance data; and design a new vehicle based on the modified IVN architecture.

In a twenty-second aspect, alone or in combination with one or more of the twentieth or twenty-first aspects, the at least one processor is configured to cause the device to: receive multiple sets of second association data associated with the vehicle type; receive multiple sets of third association data associated with a second vehicle type; receive local digital twin performance data from one or more vehicles associated with the vehicle type, one or more second vehicles associated with the second vehicle type, or both; generate a new or modified driving or maintenance profile associated with the vehicle type, the second vehicle type, or both, using one or more of the association data, the second association data, the third association data, or the local digital twin performance data; and transmit the new or modified driving or maintenance profile to one or more vehicles having the vehicle type, the second vehicle type, or both.

In a twenty-third aspect, alone or in combination with one or more of the twentieth to twenty-second aspects, the device comprises an edge server.

In a twenty-fourth aspect, alone or in combination with one or more of the twentieth to twenty-third aspects, the at least one processor is configured to cause the device to: generate aggregated digital twin information for a particular region associated with the edge server based on the association data and on second association data, digital twin performance data, or both; generate a region specific digital twin update for the particular region using the digital twin, wherein the digital twin correspond to a cloud or regional digital twin; and wirelessly transmit the region specific digital twin update to vehicles associated with the particular region.

In a twenty-fifth aspect, alone or in combination with one or more of the twentieth to twenty-fourth aspects, the cloud digital twin comprises a master digital twin for the vehicle type or a master digital twin for a particular vehicle having the vehicle type.

In a twenty-sixth aspect, alone or in combination with one or more of the twentieth to twenty-fifth aspects, the at least one processor is configured to cause the wireless communication device to: receive digital twin data from multiple vehicles in a region associated with the edge server and associated with the vehicle type; generate anonymized aggregated digital twin data associated with the vehicle type based on the received digital twin data, the anonymized aggregated digital twin data corresponding to digital twin association data, digital twin performance data, digital twin parameter output data, or a combination thereof, from the multiple vehicles; and transmit the anonymized aggregated digital twin data associated with the vehicle type to a cloud server.

In a twenty-seventh aspect, alone or in combination with one or more of the twentieth to twenty-sixth aspects, the device comprises a base station.

In a twenty-eighth aspect, alone or in combination with one or more of the twentieth to twenty-seventh aspects, the device comprises a cloud server.

In a twenty-ninth aspect, alone or in combination with one or more of the twentieth to twenty-eighth aspects, the association data is received from a vehicle of the one or more vehicles via a base station; and wherein the at least one processor is configured to cause the device to provide the update to the one or more vehicles includes to: transmit an update message to the base station and indicating the update for transmission to the one or more vehicles.

In a thirtieth aspect, alone or in combination with one or more of the twentieth to twenty-ninth aspects, the at least one processor is configured to cause the device to: receive anonymized aggregated digital twin data associated with the vehicle type from one or more edge servers, the anonymized aggregated digital twin data corresponding to digital twin association data, digital twin performance data, digital twin parameter output data, or a combination thereof, from multiple vehicles having the vehicle type, wherein the update is generated further based on the anonymized aggregated digital twin data associated with the vehicle type.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication at a vehicle, the apparatus comprising:
one or more sensors;
at least one processor; and
a memory coupled to the at least one processor,
wherein the at least one processor is configured to cause the apparatus to:
associate changes in operations of the vehicle with changes in in-vehicle network (IVN) performance and electronic control unit (ECU) performance to generate association data; and
provide the association data to a digital twin associated with the vehicle, the association data configured to cause the digital twin to model performance of the vehicle and generate modified operating parameters.

2. The apparatus of claim 1, wherein the association data includes or corresponds to a data structure or database including vehicle operations data linked with corresponding IVN and ECU performance data or to linking information which associates the vehicle operations data with the corresponding IVN and ECU performance data.

3. The vehicle of claim 1, wherein the at least one processor configured to cause the apparatus to associate the changes in the operations of the vehicle with changes in the IVN performance and the ECU performance to generate the association data includes to:
generate vehicle operations data based on at least one detected change in the operations of the vehicle over a time period;
generate IVN and ECN performance change data based on detected changes in the IVN performance and the ECU performance to over the time period; and
generate the association data by linking the vehicle operations data with the IVN and ECN performance change data.

4. The apparatus of claim 1, wherein the at least one processor configured to cause the apparatus to provide the association data includes to:
send the association data to a local digital twin of the vehicle; and
generate, using the local digital twin and the association data, the modified operating parameters for the vehicle, wherein the vehicle is operated using the modified operating parameters.

5. The apparatus of claim 4, wherein the modified operating parameters include application level parameters, IP level parameters, MAC level parameters, Physical layer parameters, or a combination thereof.

6. The apparatus of claim 4, wherein the at least one processor configured to cause the apparatus to provide the association data includes to:
update the local digital twin of the vehicle based on the modified operating parameters;
generate a digital twin update for a network digital twin associated with the vehicle based on the updated local digital twin of the vehicle; and
transmit the digital twin update to a network device including the network digital twin associated with the vehicle.

7. The apparatus of claim 1, wherein the at least one processor configured to cause the apparatus to provide the association data includes to:
transmit the association data to a network device including a network digital twin associated with the vehicle; and
receive a vehicle update for the vehicle, a digital twin update for a local digital twin associated with the vehicle, or both, based on transmission of the association data, wherein the vehicle is operated using the modified operating parameters, and wherein the modified operating parameters are indicated by the vehicle update or generated by the local digital twin based on the digital twin update.

8. The apparatus of claim 7, wherein the vehicle update includes or corresponds to a new or updated vehicle operating profile or a new or updated vehicle maintenance profile.

9. The apparatus of claim 7, wherein the digital twin update includes or corresponds to a modification to the local digital twin for a new or updated vehicle operating profile or a new or updated vehicle maintenance profile.

10. The apparatus of claim 1, further comprising:
at least one sensor configured to monitor noise associated with the IVN, the ECU, a PLC, or a combination thereof, and to generate noise frequency data, and wherein the at least one processor configured to cause the apparatus to associate the changes in the operations of the vehicle with the changes in the IVN performance and the ECU performance to generate the association data includes to:
associate the noise frequency data with vehicle operation data using a local digital twin for the vehicle to generate a portion of the association data.

11. The apparatus of claim 1, further comprising:
one or more digital twin ECU memory buffers coupled to the ECU, the one or more digital twin ECU memory buffers configured to store network and traffic condition data of the ECU, the IVN, or both, generated by the ECU during operation of the vehicle and for association with the changes in the operations of the vehicle, wherein the at least one processor is further configured to cause the apparatus to:
store the generated network and traffic condition data at the one or more digital twin ECU memory buffers temporarily when one or more buffer storage conditions are satisfied;
transmit the stored network and traffic condition data from the one or more digital twin ECU memory buffers to a local digital twin for the vehicle when one or more buffer transfer conditions are satisfied; and
transmit the generated network and traffic condition data to the local digital twin for the vehicle and independent of the one or more digital twin ECU memory buffers when the one or more buffer storage conditions are not satisfied.

12. The apparatus of claim 1, wherein the at least one processor is further configured to cause the apparatus to:
receive a vehicle connection request from a user equipment (UE) associated with the vehicle;
determine whether to offload local digital twin processing to the UE based on a digital twin processing offload condition and on one or more digital twin operating metrics or one or more vehicle operating parameters;
transmit digital twin processing data to the UE based on determining that the digital twin processing offload condition has been satisfied by the one or more digital twin operating metrics, the one or more vehicle operating parameters, or both; and
receive processed digital twin data from the UE and corresponding to the digital twin processing data.

13. The apparatus of claim 1, wherein the at least one processor is further configured to cause the apparatus to:
determine whether to reduce or suspend local digital twin processing based on a digital twin processing modification condition and on one or more digital twin operating metrics or one or more vehicle operating parameters;
reduce or suspend the local digital twin processing based on determining that the digital twin processing modification condition has been satisfied by the one or more digital twin operating metrics, the one or more vehicle operating parameters, or both; and
increase or resume the local digital twin processing based on determining that the digital twin processing modification condition is no longer satisfied by the one or more digital twin operating metrics, the one or more vehicle operating parameters, or both.

14. The apparatus of claim 1, wherein the at least one processor is further configured to cause the apparatus to:
receive a new or modified driving or maintenance profile associated with a vehicle type of the vehicle from a network device including a network digital twin for the vehicle, the new or modified driving or maintenance profile determined based on the association data and on aggregated digital twin data.

15. The apparatus of claim 1, wherein the at least one processor is further configured to cause the apparatus to:
receive a vehicle or local digital twin update for a vehicle type associated with the vehicle and from a network device including a network digital twin associated with the vehicle; and
transmit the vehicle or digital twin update to one or more other vehicles having the vehicle type using a local wireless network or D2D communications.

16. The apparatus of claim 1, wherein the at least one processor is further configured to cause the apparatus to:
receive a vehicle or local digital twin update from a second vehicle having a same vehicle type as the vehicle using a local wireless network or D2D communications.

17. The apparatus of claim 1, wherein the at least one processor is further configured to cause the apparatus to:
receive second association data or a vehicle or digital twin update from a second vehicle having a same vehicle type as the vehicle using a local wireless network or D2D communications; and
relay the second association data or a vehicle or digital twin update to a network device.

18. The apparatus of claim 1, wherein the at least one processor is further configured to cause the apparatus to:
receive or transmit the association data, a vehicle update, a digital twin update, or a combination thereof, periodically at a designated interval, at night, while charging, while connected to a particular communication protocol, upon reaching a data storage limit, or responsive to a pull request from a network device.

19. The apparatus of claim 18, wherein the vehicle update or the digital twin update is a comprehensive update or is a differential update indicating a change from a previously configured value.

20. A device for wireless communication, comprising:
at least one processor; and
a memory coupled to the at least one processor,
wherein the at least one processor is configured to cause the device to:
receive association data associated with a vehicle type generated by an in-vehicle digital twin;
evaluate in-vehicle network (IVN) performance and electronic control unit (ECU) performance with adjusted operating parameters using a cloud digital twin associated with the vehicle type and based on the association data;
determine one or more modified operating parameters for the vehicle type based on the evaluation of the IVN performance and the ECU performance with the adjusted operating parameters; and
provide an update to one or more vehicles associated with the vehicle type based on the one or more determined modified operating parameters.

21. The device of claim 20, wherein the at least one processor is further configured to cause the device to:
receive multiple sets of second association data associated with the vehicle type;
receive multiple sets of third association data associated with a second vehicle type;
receive local digital twin performance data from one or more vehicles associated with the vehicle type, one or more second vehicles associated with the second vehicle type, or both;
generate a modified IVN architecture based on an IVN architecture of the vehicle type, the second vehicle type, or both, using one or more of the association data, the second association data, the third association data, or the local digital twin performance data; and
design a new vehicle based on the modified IVN architecture.

22. The device of claim 20, wherein the at least one processor is further configured to cause the device to:
receive multiple sets of second association data associated with the vehicle type;
receive multiple sets of third association data associated with a second vehicle type;
receive local digital twin performance data from one or more vehicles associated with the vehicle type, one or more second vehicles associated with the second vehicle type, or both;
generate a new or modified driving or maintenance profile associated with the vehicle type, the second vehicle type, or both, using one or more of the association data, the second association data, the third association data, or the local digital twin performance data; and
transmit the new or modified driving or maintenance profile to one or more vehicles having the vehicle type, the second vehicle type, or both.

23. The device of claim 20, wherein the device comprises an edge server.

24. The device of claim 23, wherein the at least one processor is further configured to cause the device to:
generate aggregated digital twin information for a particular region associated with the edge server based on the association data and on second association data, digital twin performance data, or both;
generate a region specific digital twin update for the particular region using the digital twin, wherein the digital twin correspond to a cloud or regional digital twin; and
wirelessly transmit the region specific digital twin update to vehicles associated with the particular region.

25. The device of claim 20, wherein the cloud digital twin comprises a master digital twin for the vehicle type or a master digital twin for a particular vehicle having the vehicle type.

26. The device of claim 23, wherein the at least one processor is further configured to cause the device to:
receive digital twin data from multiple vehicles in a region associated with the edge server and associated with the vehicle type;
generate anonymized aggregated digital twin data associated with the vehicle type based on the received digital twin data, the anonymized aggregated digital twin data corresponding to digital twin association data, digital twin performance data, digital twin parameter output data, or a combination thereof, from the multiple vehicles; and
transmit the anonymized aggregated digital twin data associated with the vehicle type to a cloud server.

27. The device of claim 20, wherein the device comprises a base station.

28. The device of claim 20, wherein the device comprises a cloud server.

29. The device of claim 28, wherein the association data is received from a vehicle of the one or more vehicles via a base station; and wherein the at least one processor is configured to cause the device to provide the update to the one or more vehicles includes to:
transmit an update message to the base station and indicating the update for transmission to the one or more vehicles.

30. The device of claim 28, wherein the at least one processor is further configured to cause the device to:
receive anonymized aggregated digital twin data associated with the vehicle type from one or more edge servers, the anonymized aggregated digital twin data corresponding to digital twin association data, digital twin performance data, digital twin parameter output data, or a combination thereof, from multiple vehicles having the vehicle type, wherein the update is generated further based on the anonymized aggregated digital twin data associated with the vehicle type.
